(19) United States
(12) Patent Application Publication
(10) Pub. No.: US 2024/0411582 A1
(43) Pub. Date: Dec. 12, 2024

(54) DIGITAL TWIN SYSTEM, GRAPHICS PROCESSING UNIT SERVER, AND A METHOD FOR CONTROLLING THE DIGITAL TWIN SYSTEM

(71) Applicant: HYUNDAI AUTOEVER CORP., Seoul (KR)

(72) Inventors: Yoon Ji Lee, Seoul (KR); Joong Hui Kim, Seoul (KR); Hee Jin Ju, Seoul (KR); Jae Min Ko, Seoul (KR); Hye Yoon Jeong, Seoul (KR); Yun Ho Yang, Seoul (KR); Sae Hyeon Kim, Seoul (KR); Jeong Woo Woo, Seoul (KR); Ki Ho Kim, Seoul (KR)

(73) Assignee: HYUNDAI AUTOEVER CORP., Seoul (KR)

(21) Appl. No.: 18/667,188

(22) Filed: May 17, 2024

(30) Foreign Application Priority Data
Jun. 9, 2023 (KR) 10-2023-0073983
Jun. 9, 2023 (KR) 10-2023-0073984
Jun. 9, 2023 (KR) 10-2023-0073985

(51) Int. Cl. G06F 9/455

(52) U.S. Cl. CPC G06F 9/45558

(57) ABSTRACT

A digital twin system includes multiple twin model modules and multiple digital factory modules. Respective ones of the multiple digital twin system models comprises control logic and are configured to virtualize respective control systems for respective ones of multiple factories. Respective ones of the multiple digital factory modules are configured to virtualize respective ones of the multiple factories and are controlled by respective ones of the multiple twin model modules to create a virtual factory model. The digital twin system further includes a simulator module configured to manage the multiple twin model modules.

### CROSS REFERENCE TO RELATED APPLICATIONS

This application claims the benefit of and priority to Korea Patent Applications No. 10-2023-0073983, filed on Jun. 9, 2023, Korea Patent Applications No. 10-2023-0073984, filed on Jun. 9, 2023, and Korea Patent Applications No. 10-2023-0073985, filed on Jun. 9, 2023, the entire disclosures of which are hereby incorporated herein by reference in their entirety.

### FIELD OF TECHNOLOGY

The present disclosure relates to a digital twin system. More specifically, the present disclosure relates to a digital twin system and a graphics processing unit server, as well as a method for controlling a digital twin system, a method for managing configurations of a digital twin system, and a method for processing data of a digital twin system for virtualizing control processes of a factory and conducting simulations on a computer.

### BACKGROUND

Digital twin technology involves creating a virtual representation of a facility or factory in a virtual space, where the virtual representation is the same as or similar to an actual facility or factory, in order to conduct various simulations for testing purposes. This technology has been introduced and is being utilized across different fields including manufacturing, aviation, construction, healthcare, energy, national defense, city planning, etc.

The digital twin technology enables monitoring of the state of a facility or a system in a virtual space to identify timings for maintenance or repair. The digital twin technology also facilitates testing of various situations that may occur during operation, allowing for proactive prevention of unexpected accidents and reduction of accident risks. Furthermore, this technology may enhance productivity, optimize facilities, and significantly reduce costs and time associated with manufacturing trial products.

Such a digital twin system can be implemented either on a personal computer or on a server. Users can utilize a personal computer or access the relevant server to simulate a virtual factory for testing an actual factory.

However, there has been an inconvenience in that, after a digital twin system has been implemented on one computer or one server and a virtual factory has been simulated on this computer or server, if a user wants to operate the digital twin system on another computer, the relevant configuration data or attribute values must be transferred to the other computer.

In addition, if a user wants to simulate multiple virtual factories for multiple actual factories, there is no way to manage them on one server.

The discussions in this section are only to provide background information and do not constitute an admission of prior art.

### SUMMARY

Aspects of the present disclosure provide a digital twin system, a graphics processing unit server, and a method for controlling the digital twin server, managing configurations, and processing data, that enable the management of multiple virtual factories on a single simulator module.

Aspects of the present disclosure provide a digital twin system, a graphics processing unit server, and a method for controlling the digital twin server, managing configurations, and processing data, that enable virtualization of a control system of a factory and an actual factory in separate modules.

Aspects of the present disclosure provide a digital twin system, a graphics processing unit server, and a method for managing configurations, that enable the management of configurations of multiple virtual factories on a single simulator module.

Aspects of the present disclosure provide a digital twin system, a graphics processing unit server, and a method for processing data, that enable the processing of data generated as a result of simulations when a single simulator module manages the simulations for multiple virtual factories.

Technological tasks of the present disclosure are not limited to those mentioned above. Other technological tasks, which are not mentioned above, should be more clearly understood by a person having ordinary skill in the art to which the present disclosure pertains from the following descriptions.

According to an aspect of the present disclosure, a digital twin system is provided. The digital twin system includes multiple twin model modules. Respective ones of the multiple twin model modules i) comprise control logic and ii) are configured to virtualize respective control systems for respective ones of multiple factories. The digital twin system also includes multiple digital factory modules. Respective ones of the multiple digital factories i) are configured to virtualize respective ones of the multiple factories and ii) are controlled by respective ones of the multiple twin model modules to create a virtual factory model. The digital twin system additionally includes a simulator module to manage the multiple twin model modules.

According to an embodiment, the multiple twin model modules are executed on at least one graphics processing unit (GPU) server. When a first twin model module from among the multiple twin model modules is executed, the simulator module may assign resources for executing the first twin model module in the at least one GPU server.

According to an embodiment, the simulator module may be configured to set up conditions of the control logic for each twin model module to control a virtual factory.

According to an embodiment, the simulator module may create webpages to set up the conditions of the control logic and set up the conditions of the control logic using set values input through the webpages.

According to an embodiment, each twin model module and each digital factory module may communicate with each other using any one of interfaces, including a remote procedure call (RPC), a RestAPI, a Socket, a Kafka, and a Message Queue (MQ).

According to an embodiment, the factories may include production factories or logistics factories.

According to an embodiment, the simulator module may request the start, end, or restart of a simulation from each twin model module.

According to an embodiment, the simulator module may request status information from each twin model module and receive the status information from the twin model module.

According to an embodiment, the simulator module may include a model manager to manage connection with each twin model module or each digital factory module.

According to an embodiment, each of the multiple twin model modules may be set to be combined with any one of the multiple digital factory modules.

According to an embodiment, each digital factory module may report a result corresponding to a control command to a twin model module connected with this digital factory module.

According to an embodiment, the digital twin system may further include a data analyzing module to receive data from at least one of each twin model module, each digital factory module, or the simulator module and to analyze the received data.

According to another aspect of the present disclosure provides, a method for controlling a digital twin system is provided. The method includes registering and initializing, by a simulator module, models for multiple digital factories that are virtual representations of multiple factories. The method also includes requesting, by the simulator module, the start of a simulation from a first twin model from among multiple twin models, that are virtual representations of respective control systems for respective ones of the multiple factories. The method additionally includes generating, by a first twin model, control logic for a first digital factory from among the multiple digital factories. The method further includes transferring, by the first twin model, a command generated based on the control logic to a first digital factory module. The method additionally includes processing, by the first digital factory module, an operation corresponding to the command received from the first twin model to conduct a simulation.

According to an embodiment, the simulator module may operate on a central processing unit (CPU) server and the multiple twin models may be executed on at least one graphics processing unit (GPU) server.

According to an embodiment, the multiple digital factory models may be executed on the at least one GPU server.

According to an embodiment, the method may further include setting up, by the simulator module, conditions of the control logic for controlling the virtual factories with respective twin model modules.

According to an embodiment, the method may further include creating, by the simulator module, webpages to set up the conditions of the control logic.

According to an embodiment, the method may further include setting up, by the simulator module, the conditions of the control logic using set values inputted through the webpages.

According to an embodiment, each twin model module and each digital factory module may communicate with each other using any one of interfaces, including a remote procedure call (RPC), a RestAPI, a Socket, a Kafka, and a Message Queue (MQ).

According to an embodiment, the multiple factories may include production factories or logistics factories.

According to an embodiment, the method may further include requesting, by the simulator module, the start, end, or restart of a simulation from each twin model module.

According to an embodiment, the method may further include requesting, by the simulator module, status information from each twin model module and receiving the status information from the twin model module.

According to an embodiment, each of the multiple twin model modules may be set to be combined with any one of the multiple digital factory modules.

According to an embodiment, the method may further include reporting, by each digital factory module, a result corresponding to a control command to a twin model module connected with this digital factory module.

According to an embodiment, the method may further include receiving, by a data analyzing module, data from at least one of each twin model module, each digital factory module, or the simulator module. The method may also include analyzing the received data.

According to another aspect of the present disclosure, a graphics processing unit (GPU) server is provided. The GPU server includes multiple twin model modules, each comprising control logic and virtualizing a control system for each of multiple factories. The GPU server also includes multiple digital factory modules, each creating a virtual factory model by virtualizing each of the multiple factories and being controlled by each of the multiple twin model modules.

According to an embodiment, when a first twin model module from among the multiple twin model modules is executed, resources for executing the first twin model module may be assigned in the GPU server.

According to an embodiment, each twin model module may set up conditions of control logic for controlling a virtual factory.

According to an embodiment, each twin model module may receive the conditions of the control logic for controlling a virtual factory from a simulator module.

According to an embodiment, each twin model module and each digital factory module may communicate with each other using any one of interfaces, including a remote procedure call (RPC), a RestAPI, a Socket, a Kafka, and a Message Queue (MQ).

According to an embodiment, the factories may include production factories or logistics factories.

According to an embodiment, each of the multiple twin model modules may be set to be combined with any one of the multiple digital factory modules.

According to an embodiment, each digital factory module may report a result corresponding to a control command to a twin model module connected with this digital factory module.

According to another aspect of the present disclosure, a method for controlling a digital twin system is provided. The method includes receiving a request for the start of a simulation from a simulator module in a first twin model from among multiple twin models, that are virtual representations of control systems for respective multiple factories. The method also includes generating, by the first twin model, control logic for a first digital factory from among multiple digital factories, that are virtual representations of the multiple factories. The method additionally includes transferring, by the first twin model, a command generated based on the control logic to a first digital factory module. The method further includes processing, by the first digital factory module, an operation corresponding to the command received from the first twin model to conduct a simulation.

According to an embodiment, when a first twin model module from among the multiple twin model modules is executed, resources for executing the first twin model module may be assigned in the GPU server.

According to an embodiment, the method may further include setting up conditions of control logic for controlling virtual factories.

According to an embodiment, the method may further include receiving the conditions of control logic for controlling virtual factories from the simulator module.

According to an embodiment, each twin model module and each digital factory module may communicate with each other using any one of interfaces, including a remote procedure call (RPC), a RestAPI, a Socket, a Kafka, and a Message Queue (MQ).

According to an embodiment, the factories may include production factories or logistics factories.

According to an embodiment, each of the multiple twin model modules may be set to be combined with any one of the multiple digital factory modules.

According to an embodiment, the method may further include each digital factory module's reporting a result corresponding to a control command to a twin model module connected with this digital factory module.

According to another aspect of the present disclosure, a digital twin system is provided. The digital twin system includes multiple twin model modules, respective ones of the multiple twin model modules comprising control logic and virtualizing a control system for respective ones of multiple factories. The digital twin system also includes multiple digital factory modules, respective ones of the multiple digital factory modules creating respective virtual factory models by virtualizing respective factories and being controlled by respective ones of the multiple twin model modules. The digital twin system further includes a simulator module to manage the multiple twin model modules. The simulator module may be configured to set up initial data to conduct simulations using the multiple twin model modules and the multiple digital factory modules.

According to an embodiment, the initial data may be stored by being categorized depending on models of simulations.

According to an embodiment, the initial data may be stored by being categorized depending on versions of simulations.

According to an embodiment, the initial data may include categories and properties.

According to an embodiment, the simulator module may store customized data that has been altered as a result of modifying the initial data with values input through a user terminal.

According to an embodiment, when conducting a simulation, the simulator module may load the customized data to apply it to the simulation.

According to an embodiment, when conducting a simulation, the simulator module may receive a change value of the initial data input from the user terminal and apply the inputted change value to the simulation.

According to an embodiment, when conducting a simulation, the simulator module may store the change value of the initial data input from the user terminal as simulation history data.

According to an embodiment, the multiple twin model modules are executed on at least one graphics processing unit (GPU) server, and when a first twin model module from among the multiple twin model modules is executed, the simulator module may assign resources for executing the first twin model module in the at least one GPU server.

According to an embodiment, the simulator module may set up conditions of the control logic for controlling a virtual factory in each twin model module.

According to an embodiment, each twin model module and each digital factory module may communicate with each other using any one of interfaces, including a remote procedure call (RPC), a RestAPI, a Socket, a Kafka, and a Message Queue (MQ).

According to an embodiment, the factories may include production factories or logistics factories.

According to an embodiment, the simulator module may request the start, end, or restart of a simulation from each twin model module.

According to an embodiment, each of the multiple twin model modules may be set to be combined with any one of the multiple digital factory modules.

According to another aspect of the present disclosure, a method for managing configurations of a digital twin system is provided. The method includes setting up, by a simulator module, initial data to conduct simulations using multiple digital factory modules, that are virtual representations of multiple factories, and multiple twin model modules for controlling the multiple digital factory modules. The method also includes receiving, by the simulator module, a request for the start of a simulation from a user terminal. The method additionally includes transferring the initial data to a first twin model module from among the multiple twin model modules in response to the request for the start of a simulation. The method further still includes requesting, by the simulator module, the start of a simulation from the first twin model module. The method also includes generating, by the first twin model module, control logic for a first digital factory from among the multiple digital factory modules. The method additionally includes transferring, by the first twin model module, a command generated based on the control logic to the first digital factory module. The method further includes processing, by the first digital factory module, an operation corresponding to the command received from the first twin model module to conduct the simulation.

According to an embodiment, the initial data may be stored by being categorized depending on models of simulations.

According to an embodiment, the initial data may be stored by being categorized depending on versions of simulations.

According to an embodiment, the initial data may include categories and properties.

According to an embodiment, the simulator module may store customized data that has been altered as a result of modifying the initial data with values input through a user terminal.

According to an embodiment, when conducting a simulation, the simulator module may load the customized data to apply it to the simulation.

According to an embodiment, when conducting a simulation, the simulator module may receive a change value of the initial data input from the user terminal and apply the inputted change value to the simulation.

According to an embodiment, when conducting a simulation, the simulator module may store the change value of the initial data input from the user terminal as simulation history data.

According to an embodiment, the multiple twin model modules are executed on at least one graphics processing unit (GPU) server. When a first twin model module from among the multiple twin model modules is executed, the simulator module may assign resources for executing the first twin model module in the at least one GPU server.

According to an embodiment, the simulator module may set up conditions of the control logic for controlling a virtual factory in each twin model module.

According to an embodiment, each twin model module and each digital factory module may communicate with each other using any one of interfaces, including a remote procedure call (RPC), a RestAPI, a Socket, a Kafka, and a Message Queue (MQ).

According to an embodiment, the factories may include production factories or logistics factories.

According to an embodiment, the simulator module may request the start, end, or restart of a simulation from each twin model module.

According to an embodiment, each of the multiple twin model modules may be set to be combined with any one of the multiple digital factory modules.

According to another aspect of the present disclosure, a digital twin system is provided. The digital twin system includes multiple twin model modules, respective ones of the multiple twin model modules comprising control logic and virtualizing respective control systems for respective ones of multiple factories. The digital twin system also includes multiple digital factory modules, respective ones of the multiple digital factory modules creating respective virtual factory models by virtualizing respective ones of the multiple factories and being controlled by respective ones of the multiple twin model modules. The digital twin system further includes a simulator module configured to manage the multiple twin model modules. The digital twin system further includes a data analyzing module configured to analyze data related to simulations conducted by the multiple twin model modules and the multiple digital factory modules.

According to an embodiment, the data related to simulations may include result data generated after completing the conduct of the simulations.

According to an embodiment, the data related to simulations may include log data generated during conducting the simulations.

According to an embodiment, the log data may include at least one of a simulation node name, a simulation node ID, or a simulation ID.

According to an embodiment, the log data may include an application type or an application name.

According to an embodiment, the data analyzing module may analyze data related to the simulations and visualize analyzed results to display them.

According to an embodiment, the data analyzing module may visualize a system dashboard accessible by a system administrator and display it.

According to an embodiment, the system dashboard may include resource information of the digital twin system or log information of the digital twin system.

According to an embodiment, the data analyzing module may visualize a domain dashboard accessible by a user and display it.

According to an embodiment, the domain dashboard may include a single simulation dashboard and a multiple simulation dashboard.

According to an embodiment, the single simulation dashboard may include at least one of simulation summary information, palette manufacturing status, box picking status, an operation rate of each logistics workshop, a work amount of each logistics workshop, a loop inefficiency count, a list of palettes delayed in work, a list of boxes delayed in work, an operation rate of each crane, or an operation rate of each robot.

According to an embodiment, the multiple simulation dashboard may include at least of a comparison of operation rate averages of logistics workshops, a comparison of palette completion time averages, a comparison of box issue time averages, a comparison of numbers of completed palettes, a comparison of numbers of discarded boxes, or a comparison of numbers of restocked boxes during disposal.

According to an embodiment, the factories may include production factories or logistics factories.

According to an embodiment, the data analyzing module may extract result data of a simulation model created by combining at least two of items, movers, and workers.

According to another aspect of the present disclosure, a method for processing data of a digital twin system is provided. The method includes registering and initializing, by a simulator module, models for multiple digital factories, which are virtual representations of multiple factories. The method also includes requesting, by the simulator module, the start of a simulation from a first twin model from among multiple twin models that are virtual representations of control systems for the respective multiple factories. The method further includes generating, by the first twin model, control logic for a first digital factory from among the multiple digital factories. The method also includes transferring, by the first twin model, a command generated based on the control logic to a first digital factory module. The method additionally includes processing, by the first digital factory module, an operation corresponding to the command received from the first twin model to conduct a simulation. The method further includes analyzing data related to simulations conducted by the multiple twin model modules and the multiple digital factory modules.

According to an embodiment, the data related to simulations may include result data generated after completing the conduct of the simulations.

According to an embodiment, the data related to simulations may include log data generated during conducting the simulations.

According to an embodiment, the log data may include at least one of a simulation node name, a simulation node ID, or a simulation ID.

According to an embodiment, the log data may include an application type or an application name.

According to an embodiment, the method may further include analyzing data related to the simulations and visualizing analyzed results to display them.

According to an embodiment, the method may further include visualizing a system dashboard accessible by a system administrator to display it.

According to an embodiment, the system dashboard may include resource information of the digital twin system or log information of the digital twin system.

According to an embodiment, the method may further include visualizing a domain dashboard accessible by a user to display it.

According to an embodiment, the domain dashboard may include a single simulation dashboard and a multiple simulation dashboard.

According to an embodiment, the single simulation dashboard may include at least one of simulation summary information, palette manufacturing status, box picking status, an operation rate of each logistics workshop, a work amount of each logistics workshop, a loop inefficiency count, a list of palettes delayed in work, a list of boxes delayed in work, an operation rate of each crane, or an operation rate of each robot.

According to an embodiment, the multiple simulation dashboard may include at least one of a comparison of operation rate averages of logistics workshops, a comparison of palette completion time averages, a comparison of box issue time averages, a comparison of numbers of completed palettes, a comparison of numbers of discarded boxes, or a comparison of numbers of restocked boxes during disposal.

According to an embodiment, the factories may include production factories or logistics factories.

According to an embodiment, the method may further include extracting result data of a simulation model created by combining at least two of items, movers, and workers.

As described above, embodiments of the present disclosure enable a single server to conduct simulations of multiple virtual factories and manage them by a single simulator module's connecting the multiple virtual factories.

Embodiments of the present disclosure also enable various combinations of control systems and factories for conducting simulations by virtualizing each of control systems of factories and each of physical factories to be separate modules.

Further, embodiments of the present disclosure enable a single simulator module to connect multiple virtual factories and a single server to manage configurations for simulations of the multiple virtual factories.

Additionally, embodiments of the present disclosure enable a single simulator module to connect multiple virtual factories and to process data generated when conducting simulations of the multiple virtual factories.

In addition to the effects described above, various other effects directly or indirectly understood from the present disclosure may be provided.

### BRIEF DESCRIPTION OF THE DRAWINGS

In order that the disclosure may be well understood, there are now described various forms thereof, given by way of example, reference being made to the accompanying drawings, in which:

FIG. 1 is a diagram illustrating a concept of a comparison between a virtual space and an actual space, according to an embodiment of the present disclosure;

FIG. 2 is a flow diagram illustrating a control process of a digital twin system, according to an embodiment of the present disclosure;

FIG. 3 is a block diagram illustrating a digital twin system according, to an embodiment of the present disclosure;

FIG. 4 is a block diagram illustrating a digital twin system, according to an embodiment of the present disclosure;

FIG. 5 is a diagram illustrating combinations of twin models and digital factories, according to an embodiment of the present disclosure;

FIG. 6 is a diagram illustrating a process for a simulation of a factory, according to an embodiment of the present disclosure;

FIG. 7 is a diagram illustrating a concept of a simulation of a factory, according to an embodiment of the present disclosure;

FIG. 8A is a diagram illustrating a concept of a simulation of a factory using an emulator, according to an embodiment of the present disclosure;

FIG. 8B is a diagram illustrating a concept of a simulation of a factory using a twin model, according to an embodiment of the present disclosure;

FIG. 9 is a diagram illustrating operations or steps of editing and managing configurations for each model, according to an embodiment of the present disclosure;

FIG. 10 is a diagram illustrating set values for configurations for each model, according to an embodiment of the present disclosure;

FIG. 11 is a flow diagram illustrating operations or steps of editing and managing configurations for each model, according to an embodiment of the present disclosure;

FIG. 12 is a diagram illustrating a structure for generating a set of configurations, according to an embodiment of the present disclosure;

FIGS. 13A-13F are diagrams illustrating editing of sets of configurations, according to an embodiment of the present disclosure;

FIG. 14 is a diagram illustrating a flow of processing data, according to an embodiment of the present disclosure;

FIG. 15 is a diagram illustrating a method of processing data, according to an embodiment of the present disclosure;

FIG. 16 is a diagram illustrating a method of generating indexes of a simulation result, according to an embodiment of the present disclosure;

FIG. 17 is a diagram illustrating a method of generating indexes of a simulation result, according to an embodiment of the present disclosure;

FIG. 18 is a diagram illustrating indexes of a result of a first simulation, according to an embodiment of the present disclosure;

FIG. 19 is a diagram illustrating indexes of a result of a second simulation, according to an embodiment of the present disclosure;

FIG. 20 is a diagram illustrating a method of generating indexes of a simulation result, according to an embodiment of the present disclosure;

FIG. 21 is a diagram illustrating indexes of a result of a third simulation, according to an embodiment of the present disclosure;

FIG. 22 is a diagram illustrating indexes of a result of a fourth simulation, according to an embodiment of the present disclosure;

FIG. 23A and FIG. 23B are diagrams illustrating indexes of a simulation result, according to an embodiment of the present disclosure;

FIG. 24 is a configuration diagram of hardware of a computing device, according to some embodiments of the present disclosure;

FIG. 25 is a diagram illustrating a screen for editing and managing configurations for each twin model, according to an embodiment of the present disclosure;

FIG. 26 is a diagram illustrating a screen for editing and managing configurations for each digital factory, according to an embodiment of the present disclosure;

FIG. 27 is a diagram illustrating a screen for editing and managing configurations for each model, according to an embodiment of the present disclosure; and

FIG. 28 is a diagram illustrating a screen for editing and managing configurations for each model, according to an embodiment of the present disclosure.

### DETAILED DESCRIPTION

Hereinafter, embodiments of the present disclosure are described in detail with reference to the accompanying drawings. Advantages and characteristics of the present disclosure and methods to achieve them should be more clearly understood by referring to the accompanying drawings and the below described embodiments.

However, the present disclosure is not limited to the below disclosed embodiments, but may be implemented in various types different from each other. The embodiments are provided only for completing the present disclosure and for completely teaching the scope of the present disclosure to a person having ordinary skill in the art to which the present disclosure pertains. The present disclosure is defined only by the scope of the claims and their equivalents.

In describing the present disclosure, a detailed description of a well-known configuration or function related the present disclosure has been omitted where it was determined that the detailed description would unnecessarily obscure the gist of the present disclosure.

Hereinafter, embodiments of the present disclosure are described with reference to the accompanying drawings. When a component, device, element, or the like of the present disclosure is described as having a purpose or performing an operation, function, or the like, the component, device, or element should be considered herein as being “configured to” meet that purpose or perform that operation or function.

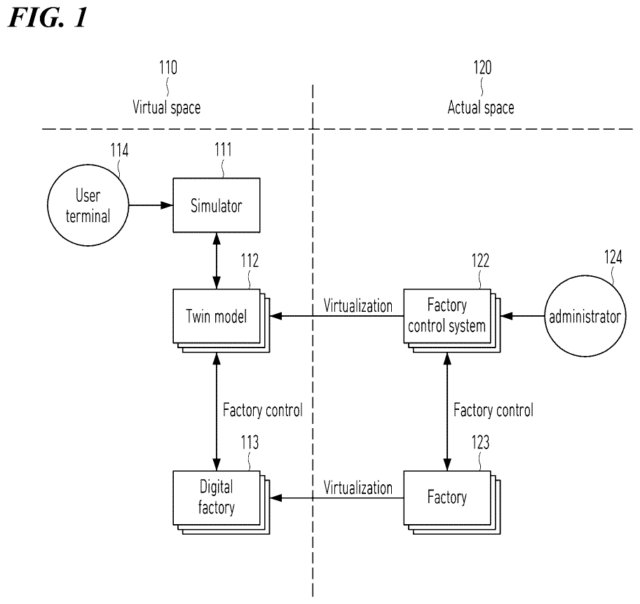

FIG. 1 is a diagram illustrating a concept of a comparison between a virtual space and an actual space, according to an embodiment of the present disclosure.

Referring to FIG. 1, a digital twin system may be implemented by conducting simulations in a virtual space 110 that includes virtual facilities or virtual factories that are the same as or similar to actual facilities in an actual space 120.

According to an embodiment, a factory 123 in the actual space may be controlled by a factory control system 122. An administrator 124 may set up control logic (or business logic) or input a control command through an input means of the factory control system 122. The factory control system 122 may generate commands for respective operations or steps according to the set control logic to control respective parts of the factory 123. For example, the factory control system 122 may cause transport of products or control movements of robots in accordance with certain control logic. In embodiments described below, the factory 123 may encompass production factories or logistics factories. However, the present disclosure is not limited thereto. For example, all the physical facilities that can be controlled by control logic may be included in the factories in various embodiments.

According to an embodiment, the factory 123 in the actual space 120 may be virtualized to be a digital factory 113. The digital factory 113 may include a software or hardware module to virtualize the factory 123 in the actual space 120 for conducting simulations through a computer or server. Accordingly, the digital factory 113 may be referred to as a digital factory module. However, the present disclosure is not limited to this term.

According to an embodiment, the factory control system 122 in the actual space 120 may be virtualized to be a twin model 112. The twin model 112 may include a software and/or hardware module to virtualize the factory control system 122 in the actual space 120 for conducting simulations through a computer or server. Accordingly, the twin model 112 may be referred to as a twin model module. However, the present disclosure is not limited to this term.

According to an embodiment, the twin model 112 may be controlled by a simulator 111. The simulator 111 may include a software or hardware module. It may be referred to as a simulator module. However, the present disclosure is not limited to this term.

According to an embodiment, multiple twin models 112 may respectively control multiple digital factories 113. The simulator 111 may create multiple digital factories 113 to conduct simulations (for example, virtualization through 3D modeling) by managing the multiple twin models 112. A user may access the simulator 111 through a user terminal 114. The user may input various configurations for conducting simulations with respect to the digital factories 113 by accessing the simulator 111 through the user terminal 114. Example embodiments in this regard are described in more detail below.

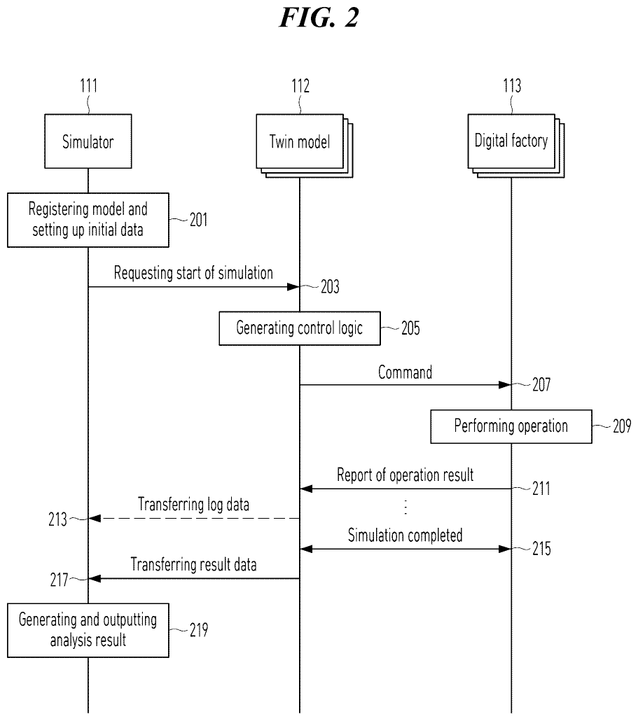

FIG. 2 is a flow diagram illustrating a control process of a digital twin system, according to an embodiment of the present disclosure.

Referring to FIG. 2, according to an embodiment, in an operation or step 201, the simulator 111 may register a model for conducting simulations with respect to a digital factory and setting up initial data. In an operation or step 203, the simulator 111 may request the start of a simulation from a specific twin model 112 (for example, a first twin model) from among the multiple twin models. In an operation or step 205, the twin model 112 may generate control logic (or business logic) in response to the request from the simulator 111. According to another embodiment, the twin model 112 may generate the control logic before the simulator 111 requests the start of a simulation and confirm the already generated control logic in response to the request for the start of a simulation. The twin model 112 may sequentially generate commands for controlling a factory based on the generated control logic, and then transfer the generated commands to the relevant digital factory 113 (for example, a first digital factory) from among multiple digital factories in an operation or step 207. The digital factory 113 may receive the commands for controlling the factory from the twin model 112 and perform operations based on the received commands in an operation or step 209. For example, the digital factory 113 may transport products, operate a conveyor belt, or operate a robot according to the commands.

According to an embodiment, in an operation or step 211, the digital factory 113 may report in real time a result of the operations to the twin model 112 or the simulator 11. In an operation or step 213, the twin model 112 may transfer the result of the operations received from the digital factory 113 as log data to the simulator 111. After the digital factory 113 has performed the operations according to the commands based on the control logic as described above, the simulation may be terminated in an operation or step 215. When the simulation is terminated, the twin model 112 may transfer result data to the simulator 111 in an operation or step 217. The simulator 111 may generate a result of analyzing the simulation based on the log data and/or result data received from the twin model 112 or the digital factory 113, and may output the generated result in an operation or step 219.

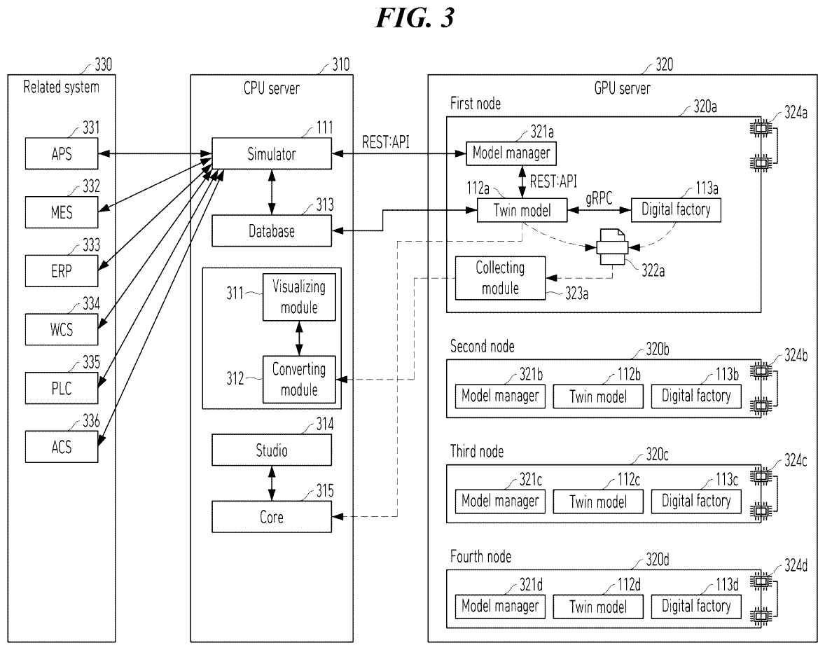

FIG. 3 is a block diagram illustrating a digital twin system, according to an embodiment of the present disclosure.

Referring to FIG. 3, a digital twin system according to an embodiment may include a central processing unit (CPU) server 310 and a graphics processing unit (GPU) server 320. Additionally, the CPU server 310 may operate in conjunction with an external related system 330 (for example, an advanced planning & scheduling system (APS) (a production planning system) 331, a manufacturing execution system (MES) (a factory management system) 332, an enterprise resource planning (ERP) 333, a warehouse control system (WCS) 334, a programmer logic control (PLC) 335, or an auto control system (ACS) (a robot control system) 336. The CPU server 310 may include a simulator 111 and a database 313. Also, the CPU server 310 may further include a visualizing module 311, a converting module 312, a studio program 314, and a core program 315. The simulator 111 may communicate with the external related system 330 through an API gateway.

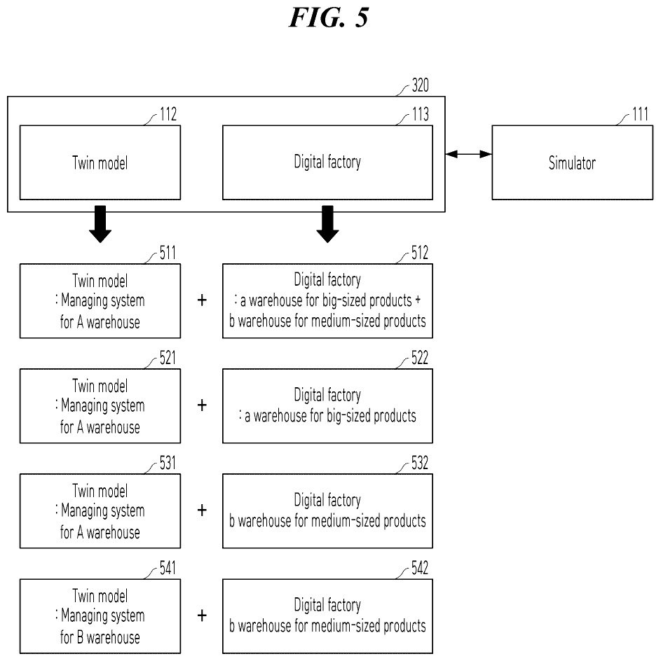

According to an embodiment, the GPU server 320 may include multiple twin models 112 and multiple digital factories 113. Each twin model 112 and each digital factory 113 may be connected with each other to conduct simulations with respect to a virtual factory. For example, the GPU server 320 may include multiple combinations of the twin models 112 and the digital factories 113 in order to conduct simulations with respect to multiple virtual factories. Examples in this regard, according to embodiments, are described in more detail below with reference to FIG. 5.

According to an embodiment, each twin model 112 and each digital factory 113 may communicate with each other using any one of interfaces, including a remote procedure call (RPC) (for example, gRPC), a RestAPI, a Socket, a Kafka, and a Message Queue (MQ). For example, a first twin model 112a may communicate with a first digital factory 113a by the RPC interface, a second twin model 112b may communicate with a second digital factory 113b by the RPC interface, a third twin model 112c may communicate with a third digital factory 113c by the RPC interface, and a fourth twin model 112d may communicate with a fourth digital factory 113d by the RPC interface.

According to an embodiment, each twin model 112 may communicate with the simulator 111 of the CPU server 310 directly or through a model manager 321 as shown in FIG. 3. For example, the first twin model 112a may communicate with a first model manager 321a by a RESTful API and the first model manager 321a may communicate with the simulator 111 by the RESTful API. The second twin model 112b may communicate with a second model manager 321b by the RESTful API and the second model manager 321b may communicate with the simulator 111 by the RESTful API. The third twin model 112c may communicate with a third model manager 321c by the RESTful API and the third model manager 321c may communicate with the simulator 111 by the RESTful API. The fourth twin model 112d may communicate with a fourth model manager 321d by the RESTful API and the fourth model manager 321d may communicate with the simulator 111 by the RESTful API. In the embodiment described below, there is provided an example in which the first twin model 112a and the first digital factory 113a operate through the first model manager 321a, corresponding to a first node 320a. The same or similar operations may be conducted in the remaining nodes 320b, 320c, 320d.

According to an embodiment, the simulator 111 may send a message related to the conduct of a simulation to each twin model 112. For example, the simulator 111 may send a request message for the start, stop, restart, or status check of a simulation to each twin model 112. The request message may include at least one of a type of a module (for example, twin model (TM) or digital factory (DF)), an internet protocol (IP) address, a port, and build version information. Each twin model 112a, 112b, 112c, 112d from among the multiple twin models 112 may receive a request message from the simulator 111 and perform processing corresponding to the request.

According to an embodiment, the digital factories 113 may receive commands based on the control logic from the twin models 112 and perform operations corresponding to the received commands. Log data 322a, generated during a simulation conducted in the first twin model 112a or the first digital factory 113a, may be collected by a collecting module 323a and transferred to a converting module 312 of the CPU server 310. The converting module 312 of the CPU server 310 may convert the collected log data 322a into processible data. A visualizing module 311 may generate visual images of result data of a simulation based on data converted by the converting module 312. According to various embodiments, at least one CPU 324 (for example, 324a, 324b, 324c, 324d) may be connected to each node in the GPU server 320 to process operations related to conduct of a simulation.

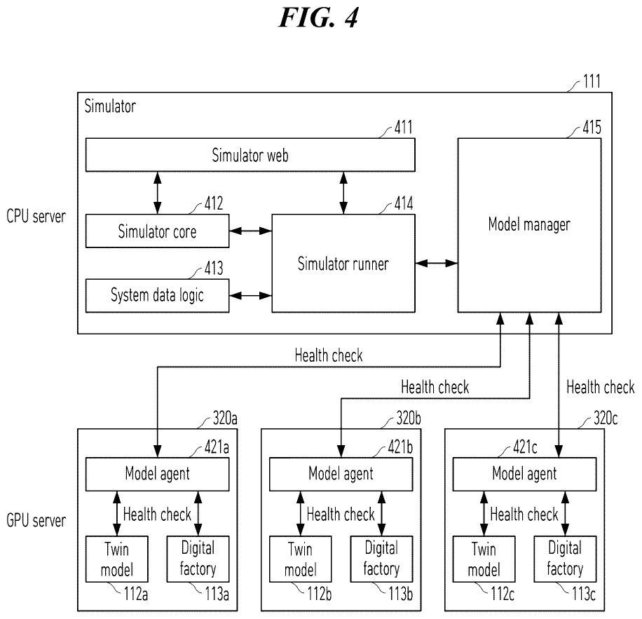

According to an embodiment, as shown in FIG. 3, at least one GPU server 320 may include multiple nodes 320a, 320b, 320c, 320d that can conduct simulations, to conduct simulations for various digital factories (for example, a 3D digital factory). In addition, according to an embodiment, a single simulator 111 included in a CPU server 310 may manage and control multiple nodes 320a, 320b, 320c, 320d that can conduct simulations. For example, the simulator 111 may check and manage in real time the status of each simulation conducted in each of multiple nodes 320a, 320b, 320c, 320d of the GPU server 320 and control operations of each simulation. When rebooting the GPU server 320 due to its problems, even if the log-in to the server is impossible due to the absence of a server administrator, a simulation may be normally conducted by the simulator 111. According to an embodiment, a model agent may be developed in a form of at least two Windows services. For example, there may be provided one Windows service to communicate with the simulator 111 by the RESTful API and another Windows service to check whether an actual simulation process normally proceeds and then to perform drive or restart. Here, commands between the Windows services may be processed by inter process communication (IPC) and Windows services installed in each node and a model manger to centrally control and monitor them may be involved. Detailed descriptions in this regard are presented below with reference to FIG. 4.

According to an embodiment, as shown in FIG. 3, Windows services implemented in the GPU server 320 may be automatically executed when the services are normally driven even if the log-on to the Windows services has not been made. Therefore, even when the GPU server 320 needs to be rebooted due to a specific reason and the log-in to the server is impossible due to the absence of a server administrator, the GPU server 320 may receive commands related to conduct of a simulation. In addition, since the simulation is a process executed by a Windows service, the simulation process may be directly controlled remotely (for example, by the simulator 111) even without direct access to a Windows server. According to an embodiment, the CPU server 310 may be a Linux server. However, the present disclosure is not limited thereto.

FIG. 4 is a block diagram illustrating a digital twin system, according to an embodiment of the present disclosure.

Referring to FIG. 4, a simulator 111 may be implemented in a CPU server. The simulator 111 may include a simulator web 411, a simulator core 412, a simulator data logic 413, a simulator runner 414, and a model manager 415. A GPU server may include multiple nodes 320a, 320b, 320c. Each node 320 may include a model agent 421, a twin model 112, and a digital factory 113. For example, a first node 320a may include a first model agent 421a, a first twin model 112a, and a first digital factory 113a. A second node 320b may include a second model agent 421b, a second twin model 112b, and a second digital factory 113b. A third node 320c may include a third model agent 421c, a third twin model 112c and a third digital factory 113c.

According to an embodiment, the simulator 111 may communicate with modules (for example, a twin model 112 or a digital factory 113) included in each node 320 directly or through the model manager 415. For example, the simulator runner 414 of the simulator 111 may conduct operations related to a simulation and the model manager 415 may perform connection or communication with each of the multiple nodes 320 so that they can share the functions.

According to an embodiment, the simulator 111 may perform a health check (normal operation check) of each node 320 by the model manager 415. For example, the simulator 111 may send a request message related to conduct of a simulation (for example, a request message including the start, stop, restart, or health check of a simulation) to each model agent 421 of each node 320 through the model manager 415. The request message may include at least one of a type of a module (for example, twin model (TM) or digital factory (DF)), an internet protocol (IP) address, a port, and build version information. Each twin model 112 may receive a request message from the simulator 111 and perform processing corresponding to the request. For example, each node 320 may check its status and report whether the node operates (for example, a result from a command for operation, re-operation, or stop) to the simulator 111.

FIG. 5 is a diagram illustrating combinations of twin models and digital factories, according to an embodiment of the present disclosure.

Referring to FIG. 5, when implementing a digital twin system according to an embodiment, various virtual factories may be implemented by separating modules for controlling factory systems and modules for virtualizing factories. For example, a twin model 112, which is a virtual representation of a factory control system, may generate a command for executing control logic (or business logic) and transfer the command to a digital factory 113. The digital factory 113, as a physical engine to execute the command received from the twin model 112, may virtualize the relevant factory and conduct a simulation. As such, various types of simulations may be conducted as shown in FIG. 5 by implementing an element in charge of control logic and an element in charge of executing commands in separate modules.

For example, a combination in which a managing system for an A warehouse is set to be a first twin model 511 and an a warehouse for big-sized products and a b warehouse for medium-sized products are set to be a first digital factory 512 may be simulated; a combination in which the managing system for the A warehouse is set to be a second twin model 521 and only the a warehouse for big-sized products is set to be a second digital factory 522 may be simulated; a combination in which the managing system for the A warehouse is set to be a third twin model 531 and only the b warehouse for medium-sized products is set to be a third digital factory 532 may be simulated; or a combination in which a managing system for a B warehouse is set to be a fourth twin model 541 and only the b warehouse for medium-sized products is set to be a fourth digital factory 542 may be simulated. The simulator 111 may combine the twin models 511, 521, 531, 541 and the digital factories 512, 522, 532, 542 in various ways.

As such, designing architectures for flexible simulations for factories is possible by implementing twin models, which are virtual representations of factory control systems, and digital factories, which are virtual representations of actual factories, in separate modules. For example, there can exist common logic or common facilities that can be applied to every factory in simulations. Here, separating an element in charge of logic and an element in charge of execution according to an embodiment enables using common logic or common facilities without implementing new logic or facilities for every factory simulation project. As described above, the twin model is a virtual representation of a factory control system of an actual system and can replicate logic of the system as well as data. In addition, instead of simply performing computation using algorithms, the twin model 112 may conduct a higher level of simulations by reflecting control logic (or business logic). The digital factory 113 may embody a 3D virtual factory based on a physical engine and construct a factory environment identical to the reality based on CAD drawings. According to an embodiment, by linking the twin model 112 and the digital factory 113 by an RPC communication interface, as described above, the twin model 112 may transfer commands to the digital factory 113 and the digital factory 113 may report a result from the commands to the twin model 112.

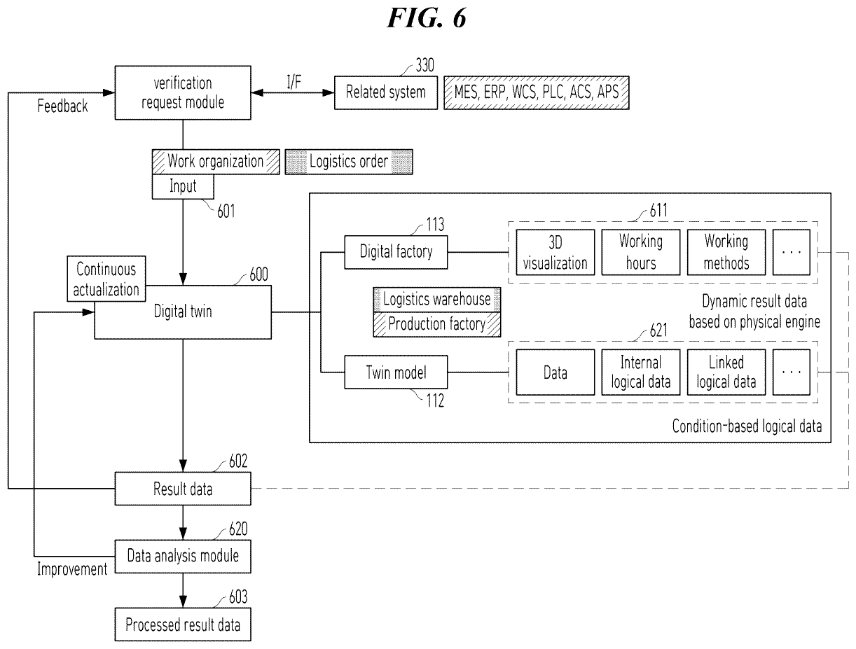

FIG. 6 is a diagram illustrating a process for a simulation of a factory, according to an embodiment of the present disclosure.

Referring to FIG. 6, for example, if the factory is a production factory, data related to work organization for simulations may be inputted 601 and if the factory is a logistics factory, data related to logistics orders for simulations may be inputted 601. As described above, a digital twin system 600 according to an embodiment may be implemented in separate modules of a twin model 112 and a digital factory 113. The twin model 112 may generate commands for operations in the digital factory 113 based on the inputted data (for example, control logic). The data processed in the twin model 112, which is condition-based logical data, may include internal logic data or linked logic data. The digital factory 113 may conduct simulations based on the commands received from the twin model 112. The data processed in the digital factory 113, which is dynamic result data based on a physical engine, may include data for 3D visualization, data related to working hours, data related to working methods, or the like. However, the present disclosure is not limited thereto.

According to an embodiment, result data 602 generated by the digital twin system 600 through simulation operations may become processed result data 603 by analysis and processing of a data analysis module 620. For example, the data generated in the digital twin system 600 may include an operation rate, an on-time component issue rate, an average processing time, or the like of each workshop in case of a logistics warehouse and may include a cell component supply time, a cell port component waiting time, or the like in case of a production factory. However, the present disclosure is not limited thereto. The data processed by the data analysis module 620 may include a minimum number of workers required for a daily production target, processible handling volume when a specific facility problem occurs, an optimum method for storing components in an automatic warehouse for production of various types of vehicles, or the like. However, the present disclosure is not limited thereto.

According to an embodiment, the result data 602 generated in the digital twin system 600 may be fed back to a verification request module to be verified and the verification request module may perform verification in conjunction with a related system 330 (for example, APS 331, MES 332, ERP 333, WCS 334, PLC 335, or ACS 336). The data analysis module 620 may input improved input values reflecting analysis results into the digital twin system 600 and this enables continuous actualization with respect to the simulations. In addition, the data analyzed and processed by the data analysis module 620 may be provided as grounds for decisions that may be reflected in a factory control system of an actual factory 120.

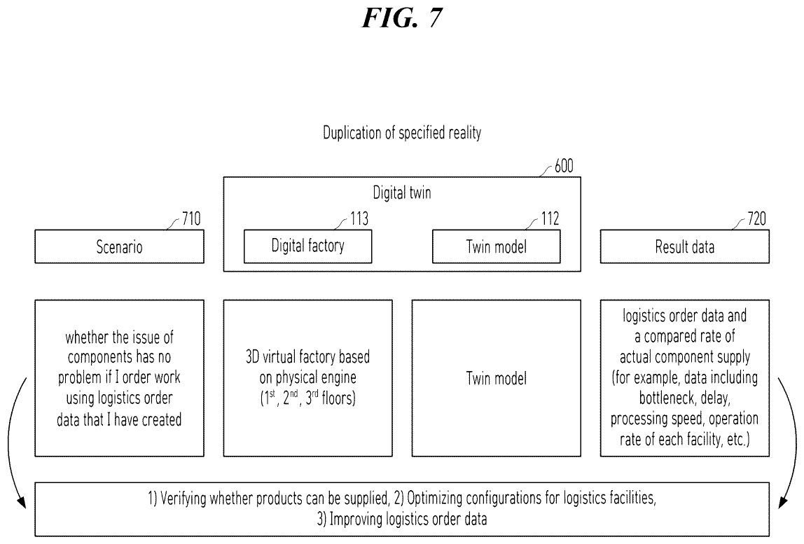

FIG. 7 is a diagram illustrating a concept of a simulation of a factory, according to an embodiment of the present disclosure.

Referring to FIG. 7, as described above, by constructing architectures for flexible factory simulations according to an embodiment, results from various scenarios may be confirmed or data may be verified using virtual spaces and simulators. For example, as described above, by establishing a similar environment regarding a desired scenario in a digital twin system and conducting a simulation, the result may be verified.

According to an embodiment, as an example of a scenario 710, in a case when a user wants to confirm or verify “whether the issue of components has no problem if I order work using logistics order data that I have created”, as described above, the user may conduct a simulation using a twin model 112 and a digital factory 113 in a digital twin system 600 and verify result data. For example, as result data from this simulation, logistics order data and a compared rate of actual component supply (for example, data including bottleneck, delay, processing speed, operation rate of each facility, etc.) may be verified. By reviewing the result data, the user, who has conducted the simulation using the digital twin system 600, may verify whether products can be supplied and optimize configurations for logistics facilities. In addition, the user may improve the logistics order data after verifying the result data.

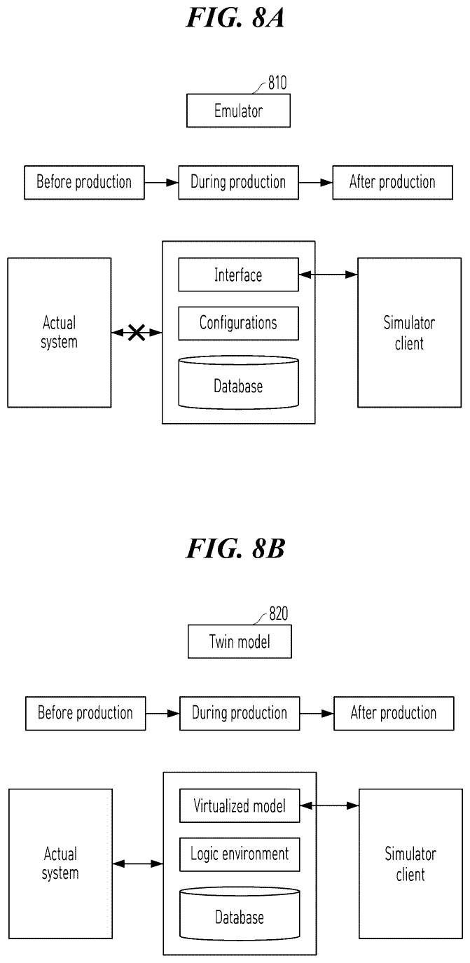

FIG. 8A is a diagram illustrating a concept of a simulation of a factory using an emulator, according to an embodiment of the present disclosure.

Referring to FIG. 8A, a simulation for a factory may be conducted using an emulator 810. For example, the emulator 810 may include an interface to communicate with a simulator client, configurations, and a data generator. The emulator 810 may include a data generating function and a responding function of the data generator so as to act as a mock-up during development. The emulator 810 may generate data suitable for a required application, which is generally usable. However, it could be difficult to apply the data to an actual system. Therefore, the data may be utilized before production, but it might not be utilized during or after production.

FIG. 8B is a diagram illustrating a concept of a simulation of a factory using a twin model, according to an embodiment of the present disclosure.

Referring to FIG. 8B, according to an embodiment, a simulation for a factory may be conducted using a twin model 820 as described above. For example, the twin model 820 may include a virtualization model, a logic environment, and a data generator. The twin model 820 is an exclusive model for a specific system and can replicate control logic of the system (for example, business logic) as well as data. The twin model 820 may be linked with an actual system. Therefore, the twin model 820 may virtualize a subject system in accordance with a purpose of a simulation. It may be used for confirming results of various scenarios for a specific system or verifying data.

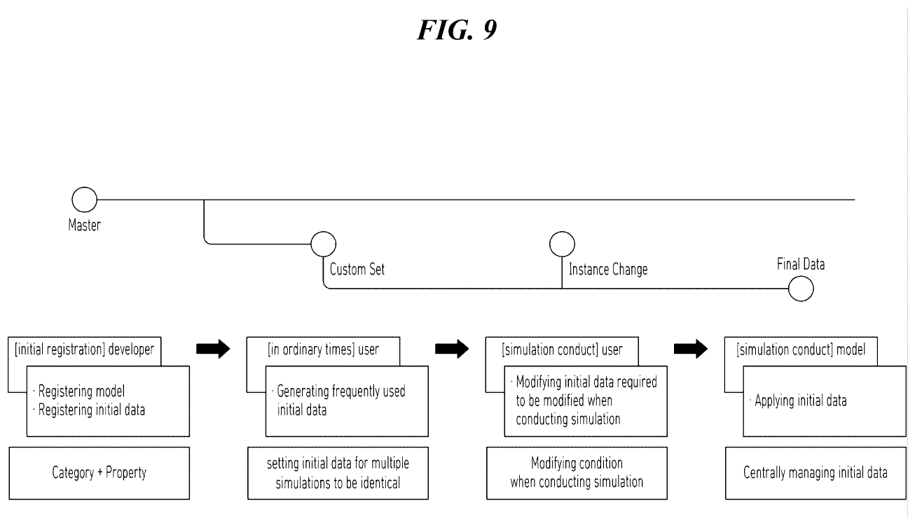

FIG. 9 is a diagram illustrating operations or steps of editing and managing configurations for each model, according to an embodiment of the present disclosure.

Referring to FIG. 9, according to an embodiment, a digital twin system may store, edit, and manage set values for each simulation model. For example, the digital twin system may set up simulations by managing various configurations. Properties of simulations may be managed by set values in order to conduct various simulations, and the priorities can be changed.

To manage the properties of the simulations and change them in various ways, an architecture may be necessary. According to an embodiment, initial data or initial data master may be set up depending on versions of models. The initial data may include categories and properties. A user may customize frequently used values by modifying the initial data. Values frequently used by the user may be referred to as a customized set (or custom set). However, the present disclosure is not limited to this term. Also, the user may newly set initial data for each simulation. Data set by the user for each simulation may be referred to as user initial data, but it is not limited to this term.

According to an embodiment, the initial data master described above may be generated or set depending on versions of a simulation model. The initial data master may be set by model and/or version. For example, initial data master of a first twin model and a first digital factory may be set and registered as first initial data master. A twin model 112 and a digital factory 113 (or a virtual factory) may generate data including categories and properties as initial data and the data may be set using various set values. The categories may be segmented in accordance with characteristics of each simulation model. For example, when the category is a buffer capacity, the properties may include a conveyor, workshop, warehouse buffer, etc. When the category is a facility capacity, the properties may include the size of a workshop, the size of a buffer bay, the numbers of racks/lanes/floors/cells of a warehouse. When the category is an operation rule, the properties may include the number of tray pushes, the number of the maximum disposal, the number of the maximum issue.

According to an embodiment, the customized set described above may be acquired by modifying or changing only frequently used values in the initial data master. When conducting a simulation, a user may import and apply a corresponding customized set. For example, storing and managing the customized set enables setting initial data for multiple simulations to be identical. When the user wants to vary input files to manage them by a simulation unit, the customized set may be used. When the user wants to conduct simulations in different nodes, the customized set may be used. In addition, when there exists common data from among data changed when conducting a simulation, the customized set may be used. In such cases, the user may establish a customized set with a frequently used condition and, when conducting a simulation, import the established customized set to apply it to the simulation.

According to an embodiment, user initial data may be newly set for every simulation. For example, the user may change set values in the initial data master or the customized set and store it as user initial data for the relevant simulation. Such changed and stored user initial data may be mapped onto a simulation history (for example, simulation time, simulation identification number). The user initial data, which is a condition applied to only the relevant simulation when it is conducted, may not affect other simulations. Since the user initial data is linked with the simulation history to be stored, the simulation may be re-conducted with the same data.

According to an embodiment, when a simulation is conducted by a simulation model, initial data as described above may be applied. As described above, the initial data may be managed in an integrated manner and stored in the database 313 by the simulator 111. For example, instead of storing the initial data by a model installed in each node (for example, a twin model 112 or a digital factory 113), the simulator 111 may centrally manage the initial data in an integrated manner so that multiple nodes may utilize it as identical common data. In addition, since data utilized in each simulation model is centrally managed, the relevant model (for example, a twin model 112 or a digital factory 113) may be involved in only conduct of a simulation and concentrate thereon.

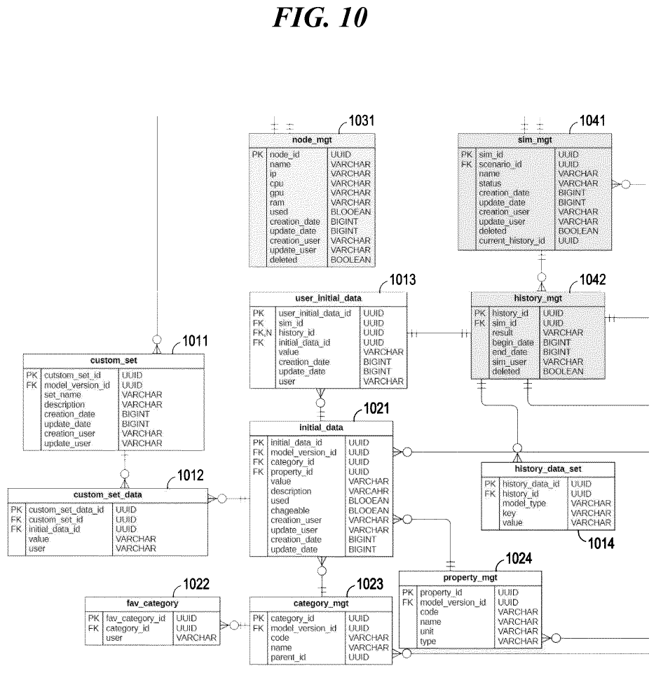

FIG. 10 is a diagram illustrating set values for configurations for each model, according to an embodiment of the present disclosure.

Referring to FIG. 10, according to an embodiment, configurations may be edited and managed for each simulation model as described by referring to FIG. 9. For example, a node management (node_mgt) 1031 may include a node ID (node_id), name, IP (ip), CPU name (cpu), GPU name (gpu), ram (ram), whether it is used (used), creation date (creation_date), update date (update_date), creation user (creation_user), update user (update_user), and whether it is deleted (deleted).

User initial data 1013 may include a user initial data ID (user_initial_data_id), simulation ID (sim_id), history ID (history_id), initial data ID (initial_data_id), value (value), creation date (creation_date), update date (update_date), and user (user).

A customized set 1011 may include a customized set ID (custom_set_id), model version ID (model_version_id), set name (set_name), description (description), creation date (creation_date), update date (update_date), creation user (creation_user), and update user (update_user).

Customized set data 1012 may include a customized set data ID (cumtom_set_data_id), customized set ID (custom_set_id), initial data ID (initial_data_id), value (value), and user (user).

Initial data (initial_data) 1021 may include an initial data ID (initial_data_id), model version ID (model_version_id), category ID (category_id), property ID (property_id), value (value), description (description), whether it is used (used), whether it is changeable (changeable), creation user (creation_user), update user (update_user), creation date (creation_date), and update date (update_date).

A simulation manager (sim_mgt) 1041 may include a simulation ID (sim_id), scenario ID (scenario_id), name (name), status (status), creation date (creation_date), update date (update_date), creation user (creation_user), update user (update_user), whether it is deleted (deleted), and current history ID (current_history_id).

A history manager (history mgt) 1042 may include a history ID (history_id), simulation ID (sim_id), result (result), beginning date (begin_date), end date (end_date), simulation user (sim user), and whether it is deleted (deleted).

A history data set (history_data_set) 1014 may include a history data ID (history_data_id), history ID (history_id), model type (model_type), key (key), and value (value).

A category manager (category_mgt) 1023 may include a category ID (category_id), model version ID (model_version_id), code (code), name (name), and parent ID (parent_id). A favorite category (fav_category) 1022 may include a favorite category ID (fav_category_id), category ID (category_id), and user (user). A property manager (property_mgt) 1024 may include a property ID (property_id), model version ID (model_version_id), code (code), name (name), unit (unit), and type (type).

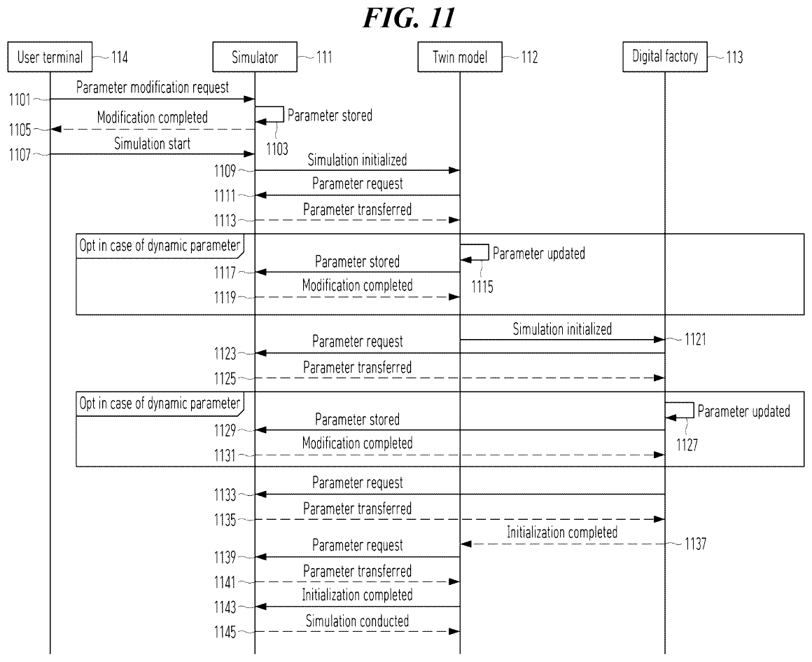

FIG. 11 is a flow diagram illustrating operations or steps of editing and managing settings for each model, according to an embodiment of the present disclosure.

Referring to FIG. 11, according to an embodiment, a simulation may be initialized. In an operation or step 1101, a user may request a modification of a parameter (for example, configuration) from a simulator 111 (for example, a simulator server) through a user terminal 114. In an operation or step 1103, the simulator 111 may store the parameter. In an operation or step 1105, the simulator 111 may notify completion of the modification to the user terminal 114.

According to an embodiment, the user may request the start of a simulation from the simulator 111 through the user terminal 114 in an operation or step 1107. The simulator 111 may request an initialization of the simulation from a twin model 112 in an operation or step 1109. The twin model 112 may request a parameter from the simulator 111 in response to the request of the simulator 111 in an operation or step 1111. The simulator 111 may transfer the corresponding parameter to the twin model 112 in response to the request in an operation or step 1113. Here, if the parameter is a dynamic parameter, the twin model 112 may update the transferred parameter in an operation or step 1115. The twin model 112 may transfer the updated parameter to the simulator 111 and request the storage of the updated parameter from the simulator 111 in an operation or step 1117. The simulator 111 may store the updated parameter and send a message indicating completion of the modification to the twin model 112 in an operation or step 1119.

According to an embodiment, the twin model 112 may request an initialization of a simulation from a digital factory 113 after the update of the parameter has been completed in an operation or step 1121. The digital factory 113 may request a parameter from the simulator 111 in response to the request for the initialization in an operation or step 1123. The simulator 111 may transfer the corresponding parameter to the digital factory 113 in response to the request in an operation or step 1125. Here, if the parameter is a dynamic parameter, the digital factory 113 may update the transferred parameter in an operation or step 1127. The digital factory 113 may transfer the updated parameter to the simulator 111 and request the storage of the updated parameter from the simulator 111 in an operation or step 1129. The simulator 111 may store the updated parameter and send a message indicating completion of the modification to the digital factory in an operation or step 1131. The digital factory 113 may request a parameter from the simulator 111 after the modification of the parameter has been completed in an operation or step 1133. The simulator 111 may transfer the corresponding parameter to the digital factory 113 in response to the request in an operation or step 1135. The digital factory 113 that has received the parameter may send a message indicating completion of the initialization to the twin model 112 in an operation or step 1137.

According to an embodiment, after having received the message indicating completion of the initialization, the twin model 112 may request a parameter from the simulator 111 in an operation or step 1139. The simulator 111 may transfer the corresponding parameter to the twin model 112 in response to the request in an operation or step 1141. The twin model 112 that has received the parameter may send a message indicating completion of the initialization to the simulator 111 in an operation or step 1143. The simulator 111 that has received the message indicating completion of the initialization may send a message indicating conduct of the simulation in an operation or step 1145. The twin model 112 that has received the message indicating conduct of the simulation may conduct the simulation in conjunction with the digital factory 113.

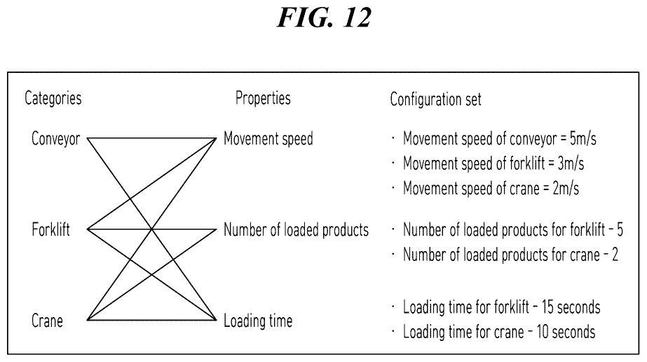

FIG. 12 is a diagram illustrating a structure for generating a set of configurations, according to an embodiment of the present disclosure.

Referring to FIG. 12, according to an embodiment, configuration sets may be created by combinations of categories and properties. For example, the categories may include a conveyor, a forklift, and a crane. The properties may include the movement speed, the number of loaded products, and the loading time.

According to an embodiment, the conveyor may be mapped onto the movement speed or the loading time. The forklift or the crane may be mapped respectively onto the movement speed, the number of loaded products, or the loading time. As shown FIG. 12, a configuration set, including the movement speed of the conveyor set to 5 m/s, the movement speed of the forklift set to 3 m/s, and the movement speed of the crane set to 2 m/s, may be established. The number of loaded products for the forklift may be set to 5 and the number of loaded products for the crane may be set to 2. The loading time for the forklift may be set to 15 seconds and the loading time for the crane may be set to 10 seconds.

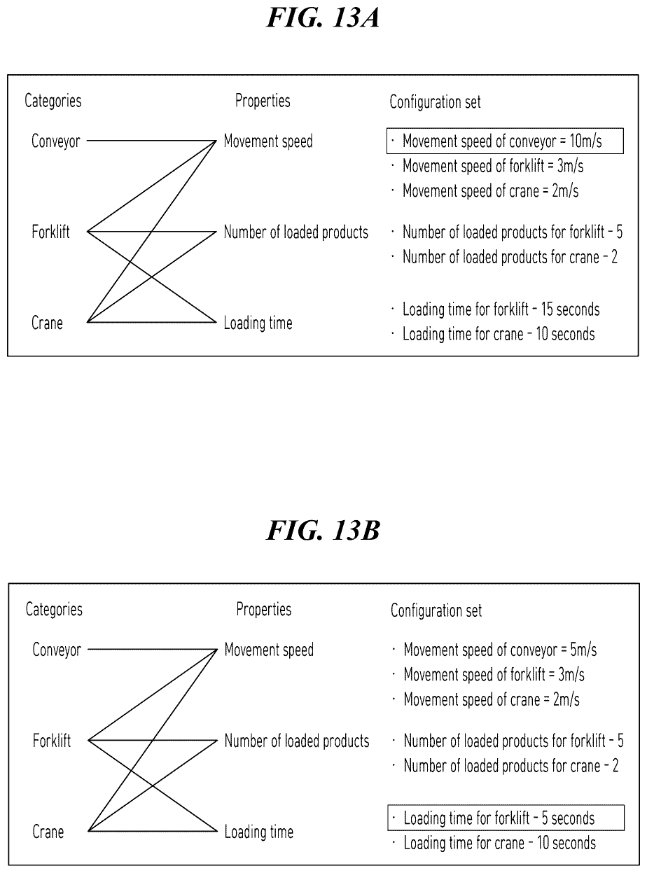

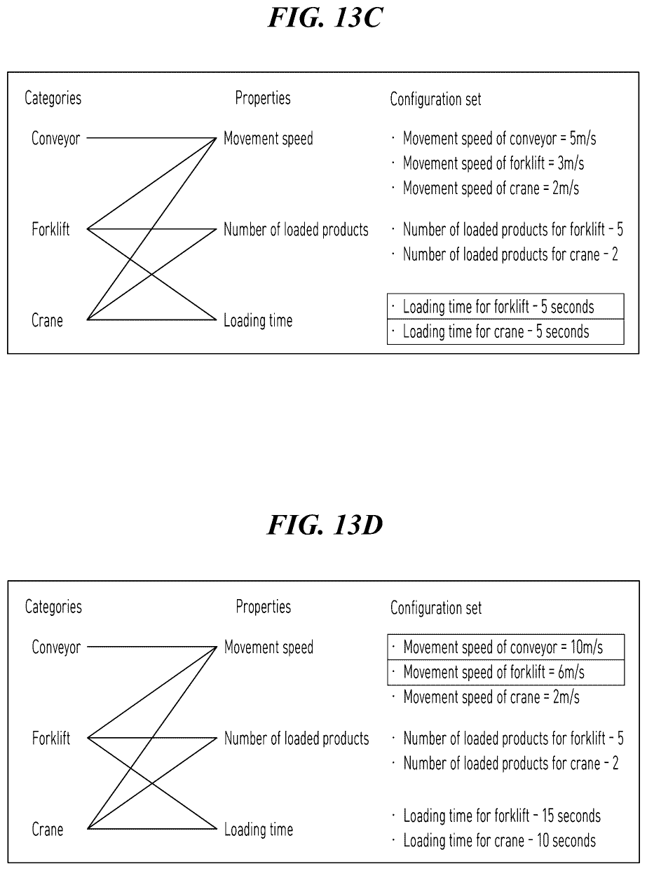

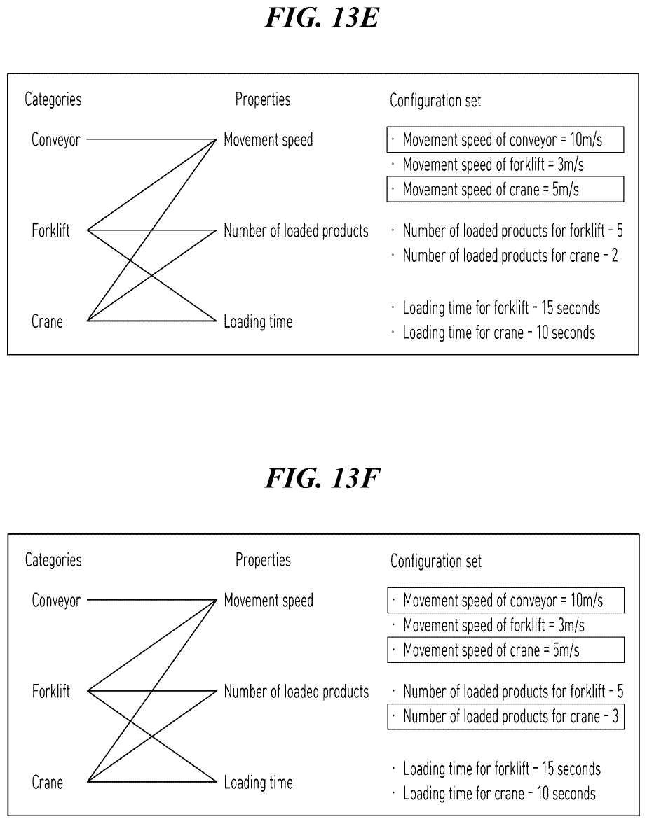

The configuration sets as described above and shown in FIG. 12 may be stored as a history as simulations are conducted. Here, by modifying a specific set, another customized set may be created using a branch structure. Examples of creating customized sets using a branch structure, according to embodiments, are described in more detail below with reference to FIGS. 13A-13F.

FIGS. 13A-13F are diagrams illustrating editing of sets of configurations, according to an embodiment of the present disclosure.

Referring to FIG. 13A, according to an embodiment, a new customized set may be created by modifying the movement speed of the conveyor from 5 m/s to 10 m/s in the configuration set of FIG. 12. Referring to FIG. 13B, a new customized set may be created by modifying the loading time for the forklift from 15 seconds to 5 seconds in the configuration set of FIG. 12. Referring to FIG. 13C, a new customized set may be created by further modifying the loading time for the crane from 10 seconds to 5 seconds in the configuration set of FIG. 13B. Referring to FIG. 13D, a new customized set may be created by further modifying the movement speed of the forklift from 3 m/s to 6 m/s in the configuration set of FIG. 13A. Referring to FIG. 13E, a new customized set may be created by further modifying the movement speed of the crane from 2 m/s to 5 m/s in the configuration set of FIG. 13A. Referring to FIG. 13F, a new customized set may be created by further modifying the number of loaded products for the crane from 2 to 3 in the configuration set of FIG. 13E.

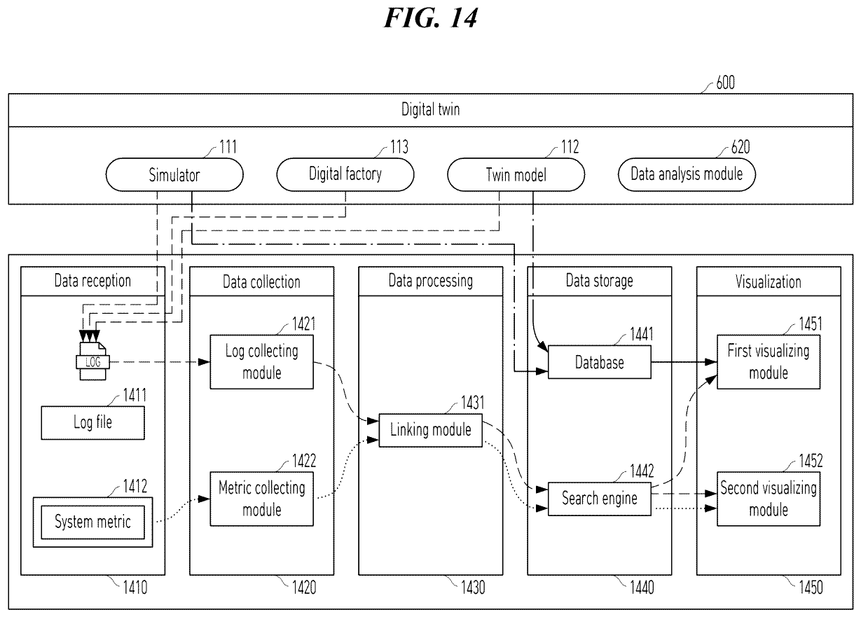

FIG. 14 is a diagram illustrating a flow of processing data, according to an embodiment of the present disclosure.

Referring to FIG. 14, according to an embodiment, a digital twin system 600 may include a simulator 111, a twin model 112, a digital factory 113, and a data analysis module 620.

According to an embodiment, in a data reception operation or step 1410, log data generated in real time in the simulator 111, the data receiving twin model 112, and the digital factory 113 may be created into a log file 1411. In a data collection operation or step 1420, a data collecting module 1421 may collect the log data. For example, the data collecting module 1421 may be implemented by an application program such as ‘Filebeat’, but it is not limited thereto. In the aforementioned data collection operation or step 1420, a metric collecting module may collect system metrics 1412. For example, the metric collecting module 1422 may be implemented by an application program such as ‘Metricbeat’. However, the present disclosure is not limited thereto.

According to an embodiment, in a data processing operation or step 1430, a linking module 1431 may process the log data collected by the log collecting module 1421 and the metric data collected by the metric collecting module 1422 by linking these two pieces of data with each other. For example, the linking module 1431 may be implemented by an application program such as ‘Logstash’. However, the present disclosure is not limited thereto.

According to an embodiment, in a data storage operation or step 1440, a data base 1441 may store simulation result data generated by the simulator 111 and the twin model 112. In the data storage operation or step 1440, a search engine 1442 may receive the log data and the metric data from the linking module 1431 and perform a search based on these pieces of data. For example, the search engine 1442 may be implemented by an application program such as ‘Elasticsearch’. However, the present disclosure is not limited thereto.

According to an embodiment, in a visualization operation or step 1450, a first visualizing module 1451 may visually display an analysis result based on the simulation result data stored in the database 1441 and the log data received by the search engine 1442. For example, the first visualizing module 1451 may be implemented by an application program such as ‘Grafana’, but it is not limited thereto. In the visualization operation or step 1450, a second visualizing module 1452 may receive the log data and the metric data from the search engine 1442 and visually display an analysis result. For example, the second visualizing module 1452 may be implemented by an application program such as ‘Kibana’, but it is not limited thereto.

According to an embodiment, the log data collected in the data collection step and the simulation results of FIG. 14 are as in Table 1 below.

TABLE 1

| Name of | | | |
|---|---|---|---|
| Property | Type | Description | Example |
| node_name | string | simulation node name | NODE-1 |
| node_id | uuid | simulation node ID | 029853a7-5b58-4142-8aa5-8fa4cb461462 |
| sim_id | uuid | simulation ID | 5b9a4613-355d-4d7b-8174-3cd3def06bce |
| app_type | string | application type | TM |
| | | (DF: virtual factory, | |
| | | TM: twin model) | |
| app_name | string | application name | LCS |
| caller | string | actant of call | com.hae.df.ECS.getPartInfo |
| call_type | string | type of called function | 1646282172407 |
| call_name | string | called function | com.hae.df.PartInfoManager.getPartInfo |
| call_time | long | time point of call | 1646282172407 |
| | | (millisecond) | |
| call_parameter | string | parameters of | { |
| | | called function | part_no: “6750-GI900”, |
| | | | part_type: “B” |
| | | | } |
| call_return | string | return value of | { |
| | | called function | part_no: “6750-GI900”, |
| | | | part_name: “ASSY MIRROR LF”, |
| | | | part_type: “B”, |
| | | | part_lane: [2, 3, 4] |
| | | | } |
| info | string | additional information | { |
| | | | rpc_name: “ArravalGtp”, |
| | | | rpc_parameter: {?? |
| | | | } |

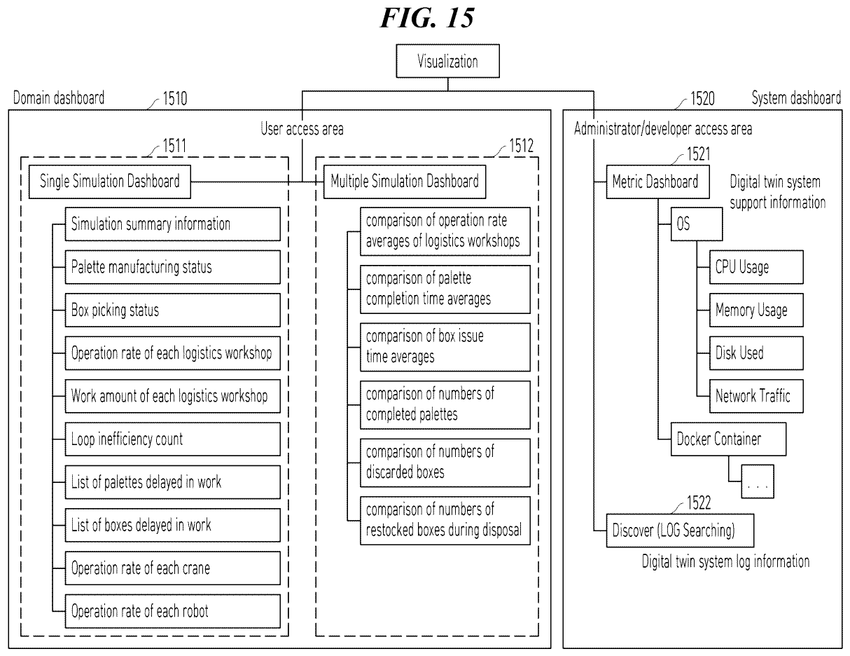

FIG. 15 is a diagram illustrating a method of processing data, according to an embodiment of the present disclosure.

Referring to FIG. 15, data visualized in the visualization operation or step 1450 as described above by referring to FIG. 14 may be divided into data of a domain dashboard 1510 and data of a system dashboard 1520. The domain dashboard 1510, which is a user access area, may be divided into a single simulation dashboard 1511 and a multiple simulation dashboard 1512.

According to an embodiment, the single simulation dashboard 1511 may include simulation summary information, palette manufacturing status, box picking status, an operation rate of each logistics workshop, a work amount of each logistics workshop, a loop inefficiency count, a list of palettes delayed in work, a list of boxes delayed in work, an operation rate of each crane, and an operation rate of each robot. The multiple simulation dashboard 1512 may include a comparison of operation rate averages of logistics workshops, a comparison of palette completion time averages, a comparison of box issue time averages, a comparison of numbers of completed palettes, a comparison of numbers of discarded boxes, and a comparison of numbers of restocked boxes during disposal.

According to an embodiment, the system dashboard 1520, which is an administrator or a developer access area, may include a metric dashboard 1521 and a discover 1522. The metric dashboard 1521 may include information regarding an operating system (OS) and a Docker Container as digital twin system support information. The information regarding the OS may include CPU usage, memory usage, disk usage, network traffic, etc. The information regarding the discover 1522 may include digital twin system log information.

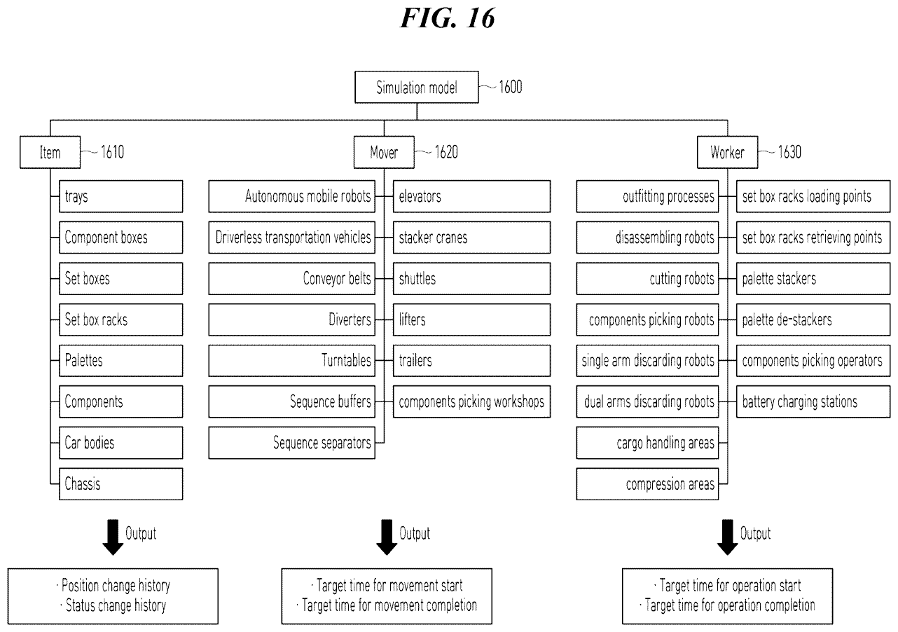

FIG. 16 is a diagram illustrating a method of generating indexes of a simulation result, according to an embodiment of the present disclosure.

Referring to FIG. 16, as described above, simulation result indexes (for example, logistics simulation result indexes) may be created based on log data collected as a simulation is conducted. Here, for comparing a simulation result with an actual operation result, numerical values, acquired during a simulation as well as result values after completion of the simulation, may also be main indexes. According to an embodiment, for the storage and indexation of values acquired during a simulation, whenever communication between the twin model 112 and the digital factory 113 is performed during a simulation, the relevant values may be recorded in a predetermined log data format and the method name, time, status, position, etc. may be verified from log data to make them as indexes. According to an embodiment, when creating a simulation model data may be divided into data regarding items 1610, data regarding movers 1620, and data regarding workers 1630 and these pieces of data may be combined. Indexes may be generated by utilizing the combined data when conducting a simulation.

According to an embodiment, the log data format may be “node_name|node_id|sim_id|app_type|app_name|caller|call_type|call_name|call time call_parameter|call_return|info”, but it is not limited thereto.

Here, as a first example, an index may be created by searching for an operation with a method name in the ‘caller’ or ‘call_name’ and basing on the time when the operation is performed. As a second example, an index for each workshop may be created by searching for an operation with a method name in the ‘caller’ or ‘call_name’ and a place where the operation is performed in the ‘call_parameter’. As a third example, an index for each facility may be created by searching for an operation with a method name in the ‘caller’ or ‘call_name’ and a facility in the ‘call_parameter’.

According to an embodiment, items 1610 of FIG. 16 may include trays, component boxes, set boxes, set box racks, palettes, components, car bodies, chassis, etc. A position change history or a status change history may be identified based on the items 1610. Movers 1620 may include autonomous mobile robots, driverless transportation vehicles, conveyor belts, diverters, turntables, sequence buffers, sequence separators, elevators, stacker cranes, shuttles, lifters, trailers, and components picking workshops. A target time for movement start and a target time for movement completion may be identified based on the mover 1620. Workers 1630 may include outfitting processes, disassembling robots, cutting robots, components picking robots, single arm discarding robots, dual arms discarding robots, cargo handling areas, compression areas, set box racks loading points, set box racks retrieving points, palette stackers, palette de-stackers, components picking operators, and battery charging stations. A target time for operation start and a target time for operation completion may be identified based on the workers 1630.

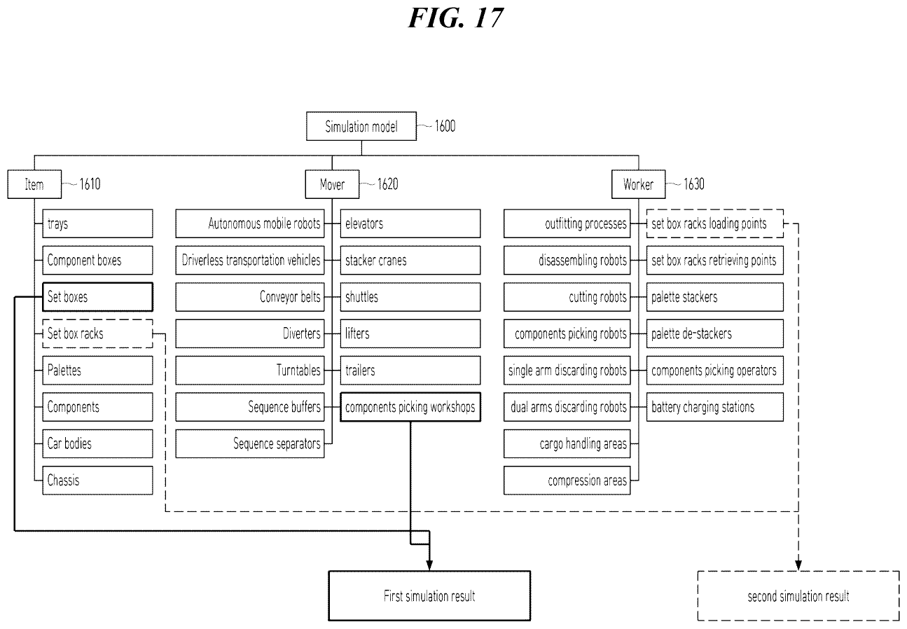

FIG. 17 is a diagram illustrating a method of generating indexes of a simulation result, according to an embodiment of the present disclosure.

Referring to FIG. 17, simulation models replicating actual operations may be created by combining the items 1610, the movers 1620, and the workers 1630 shown in FIG. 16 and result data from conduct of the simulation models may be extracted.

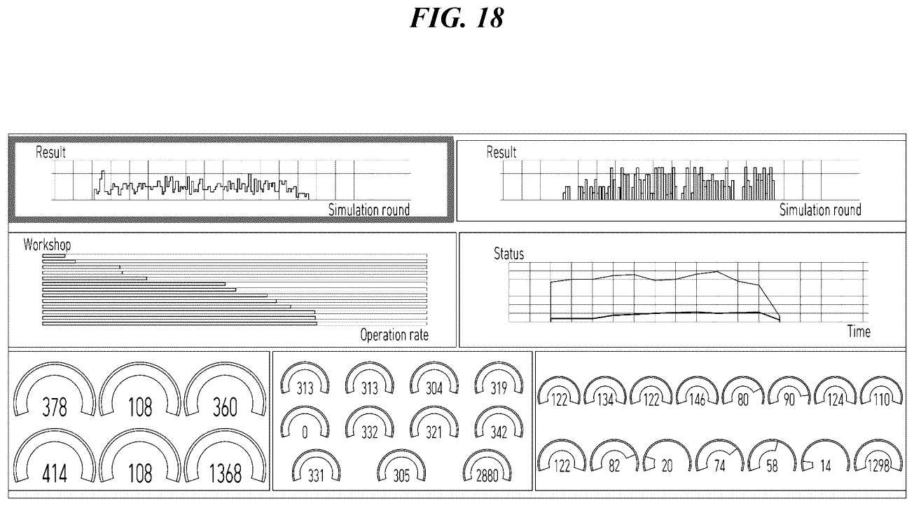

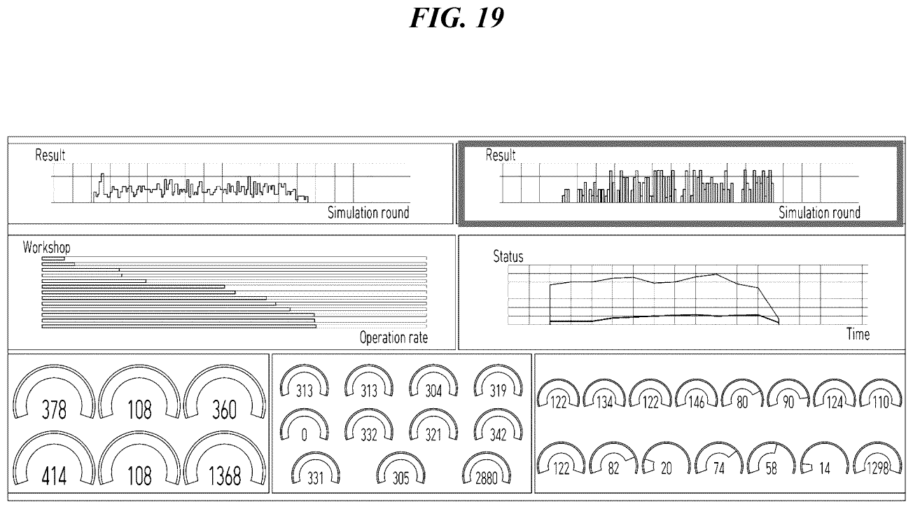

According to an embodiment, a result of a first simulation acquired from the combination of log data of the set boxes and the components picking workshops may be created and displayed as a result index chart as shown in FIG. 18. A result of a second simulation acquired from the combination of log data of the set box racks and the set box racks loading points may be created and displayed as a result index chart as shown in FIG. 19.

FIG. 18 is a diagram illustrating indexes of a result of a first simulation, according to an embodiment of the present disclosure. FIG. 19 is a diagram illustrating indexes of a result of a second simulation, according to an embodiment of the present disclosure.

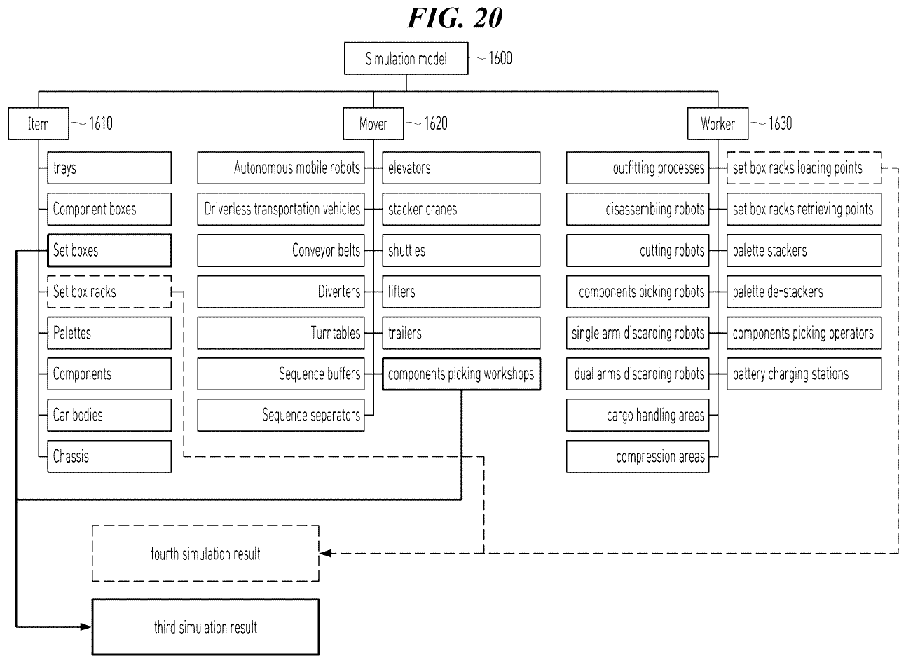

FIG. 20 is a diagram illustrating a method of generating indexes of a simulation result, according to an embodiment of the present disclosure.

Referring to FIG. 20, simulation models replicating actual operations may be created by combining the items 1610, the movers 1620, and the workers 1630 shown in FIG. 16 and result data from conduct of the simulation models may be extracted.

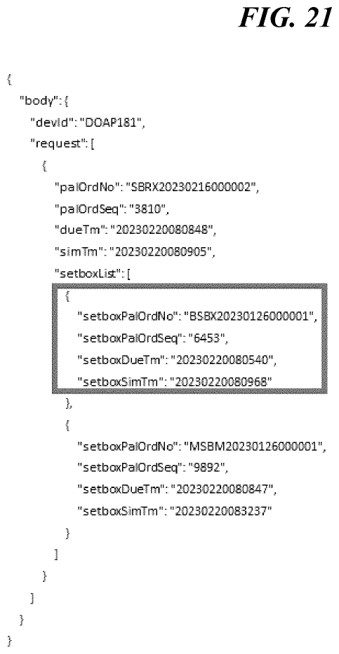

According to an embodiment, a result of a third simulation may be acquired by JavaScript Object Notation (JSON) extraction as shown in FIG. 21 by combining log data of the set boxes and the components picking workshops. For example, indexes of an actual operation and a simulation may be acquired by the JSON extraction, and then, they may be compared and analyzed.

FIG. 21 is a diagram illustrating indexes of a result of a third simulation, according to an embodiment of the present disclosure. Referring to FIG. 21, the “setboxDueTm” may indicate an expected completion time for an actual operation and the “setboxSimTm” may indicate an operation completion time verified in a simulation. Through the comparison of the two values, prediction and verification for the actual operation may be possible.

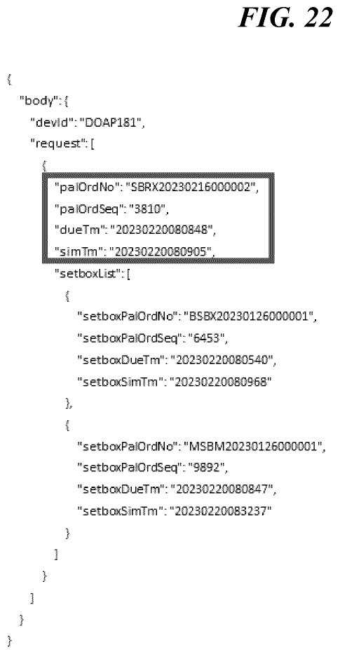

In addition, according to an embodiment, a result of a fourth simulation may be acquired by the JSON extraction as shown in FIG. 22 by combining log data of the set box racks and the set box racks loading points. For example, for each items, indexes of an actual operation and a simulation may be acquired by the JSON extraction, and then, they may be compared and analyzed.

FIG. 22 is a diagram illustrating indexes of a result of a fourth simulation, according to an embodiment of the present disclosure. Referring to FIG. 22, the “dueTm” may indicate an expected completion time for an actual operation and the “simTm” may indicate an operation completion time verified in a simulation. Through the comparison of the two values, prediction and verification for the actual operation may be possible.

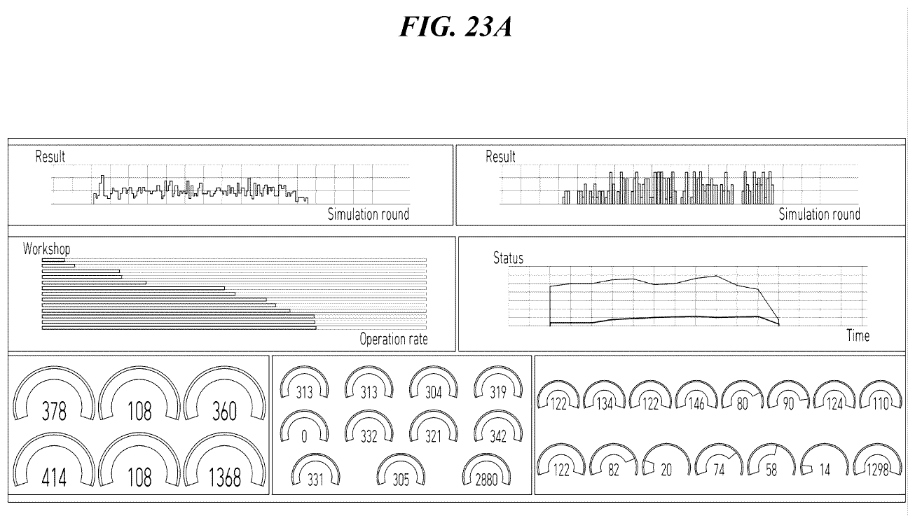

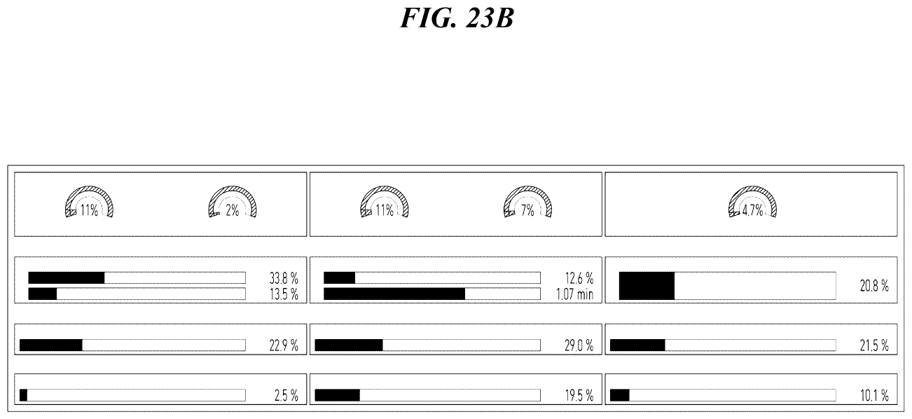

FIG. 23A and FIG. 23B are diagrams illustrating indexes of a simulation result, according to an embodiment of the present disclosure. FIG. 23A is a diagram illustrating a result analysis of a single simulation and FIG. 23B is a diagram illustrating a result analysis of multiple simulations.

Referring to FIG. 23A, according to an embodiment, simulation summary information may be displayed as a list of functions in accordance with a logistics simulation result. Additionally, manufacturing status of set boxes/racks and picking status of components boxes may be represented by time graphs. An operation rate for each PPS workshop and a list of set box racks delayed in work may be represented by bar graphs and a work amount of each PPS workshop may be represented by a time graph and a gauge. A loop inefficiency count and a list of components delayed in work may be represented by a form of tables.

Referring to FIG. 23B, according to an embodiment, as a list of functions in accordance with results of logistics simulations, after multiple simulations have been conducted, results from the simulations may be compared with each other and represented by graphs. For example, by indicating an operation rate, an average of times for completing set boxes, an average of times for completing set box racks, an average of times for issuing component boxes, the number of completed set boxes, the number of completed set box racks, the number of discarded component boxes, and the number of restocked component boxes during disposal of each simulation, the results of the multiple simulations can be compared.

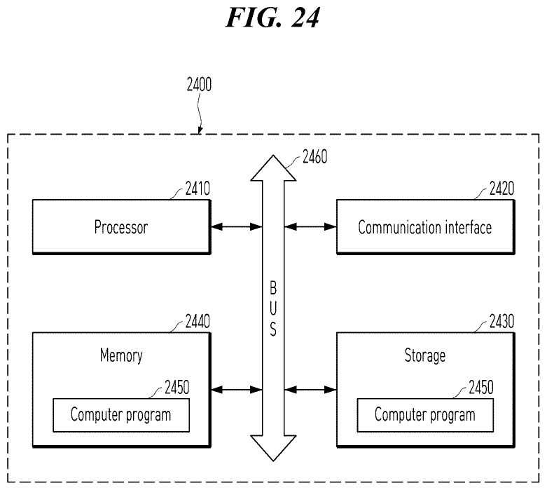

FIG. 24 is a configuration diagram of hardware of a computing device, according to some embodiments of the present disclosure.

Referring to FIG. 24, each device or module forming a digital twin system (for example, a twin model module, a digital factory module, or a simulator module) may consist of a computing device 2400. For example, the computing device 2400 may include at least one processor 2410, a system bus 2460, a communication interface 2420, a memory 2440 to load a computer program 2450 to be executed by the processor 2410, and a storage 2430 to store the computer program 2450.

The processor 2410 generally controls operations of the respective components of the computing device 2400. The processor 2410 may execute computations with respect to at least one application or program to perform methods/operations according to various embodiments of the present disclosure. The memory 2440 stores various data, commands, and/or information. The memory 2440 may load at least one computer program 2450 from the storage 2430 in order to perform methods/operations according to various embodiments of the present disclosure. The bus 2460 provides communication between the components of the computing device 2400. The communication interface 2420 supports internet communication of the computing device 2400. The storage 2430 may non-provisionally store at least one computer program 2450. A computer program 2450 may include one or more instructions for implementing methods/operations according to various embodiments of the present disclosure. When the computer program 2450 is loaded in the memory 2440, the processor 2410 may execute the one or more instructions to perform methods/operations according to various embodiments of the present disclosure.

The computer program 2450 may include instructions for performing methods/operations according to various embodiments of the present disclosure.

For example, the computer program 2450 may include instructions for a simulator module's registering and initializing models for multiple digital factories, which are virtual representations of multiple factories; the simulator module's requesting the start of a simulation from a first twin model from among multiple twin models, which are virtual representations of control systems for the respective multiple factories; the first twin model's generating control logic for a first digital factory from among the multiple digital factories; and the first twin model's transferring commands generated based on the control logic to a first digital factory module.

In addition, the computer program 2450 may include instructions for the first twin model's receiving a request for the start of a simulation from the simulator module, wherein the first twin model is one of the multiple twin models, which are virtual representations of control systems for the respective multiple factories; the first twin models' generating control logic for the first digital factory from among the multiple digital factories, which are virtual representations of the multiple factories; the first twin model's transferring a command generated based on the control logic to the first digital factory module; the first digital factory module's processing an operation corresponding to the command received from the first twin model to conduct a simulation.

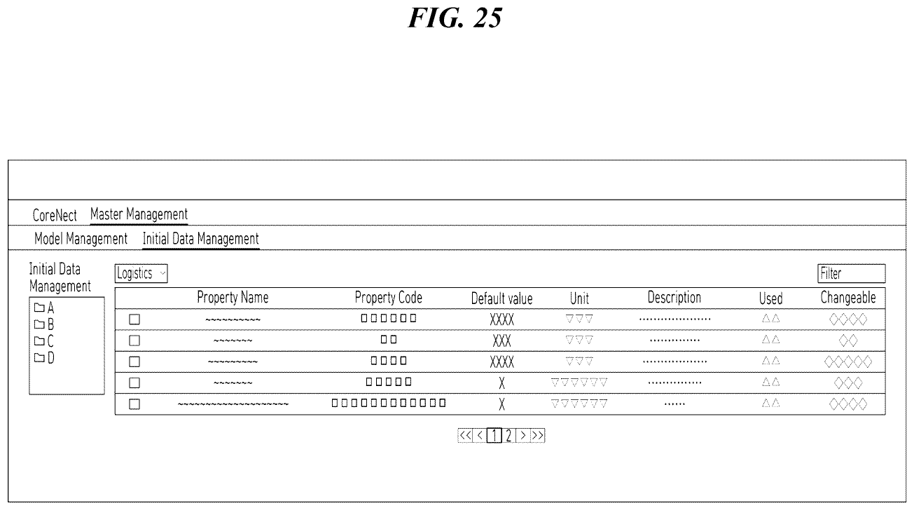

Hereinafter, screens for editing and managing configurations for each simulation model, according to embodiments, are described with reference to FIGS. 25-28.

FIG. 25 is a diagram illustrating a screen for editing and managing configurations for each twin model, according to an embodiment of the present disclosure.

Referring to FIG. 25, on the screen for editing and managing configurations for each twin model, the name and version information of the model may be displayed. In addition, additional information such as a name, code, default value, unit, detailed description, whether it is used, whether it can be changed, etc. for each property may also be displayed.

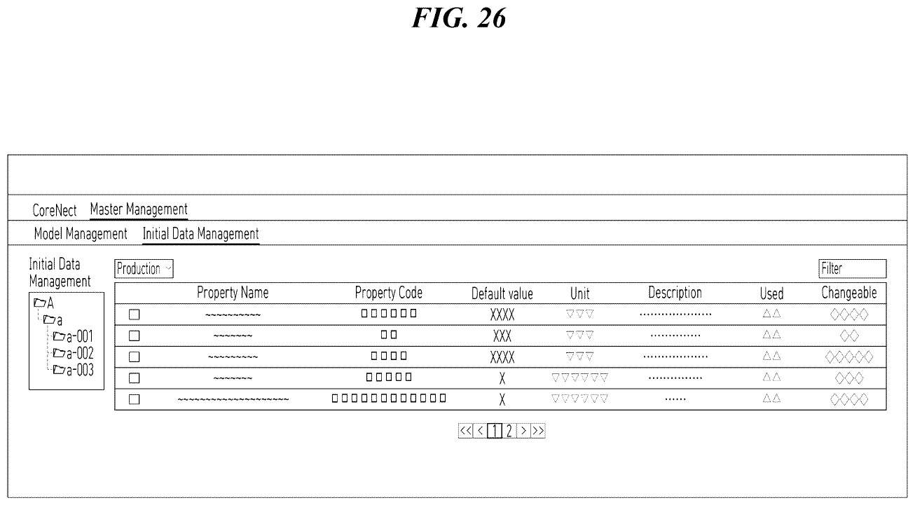

FIG. 26 is a diagram illustrating a screen for editing and managing configurations for each digital factory, according to an embodiment of the present disclosure.

Referring to FIG. 26, on the screen for editing and managing configurations for each digital factory, the name and version information of the model may be displayed. In addition, additional information such as a name, code, default value, unit, detailed description, whether it is used, whether it can be changed, etc. for each property may also be displayed.

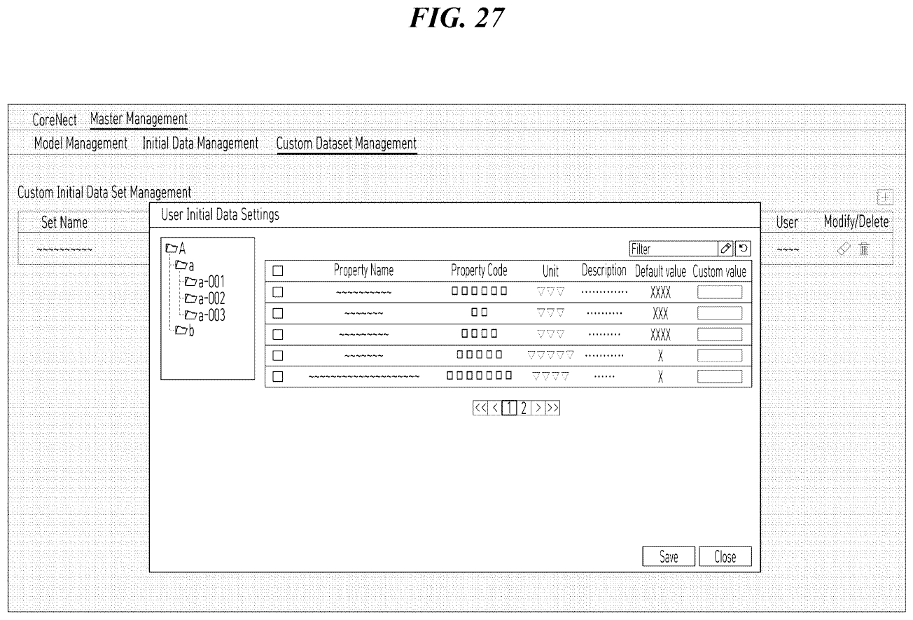

FIG. 27 is a diagram illustrating a screen for editing and managing configurations for each model, according to an embodiment of the present disclosure.

Referring to FIG. 27, according to an embodiment, user initial data may be set up. For example, as the user initial data, names, codes, units, detailed descriptions, and default values of properties may be displayed. Here, a user may set up a customized set by inputting customized values for the respective properties. A customized set is established using initial values frequently utilized by the user as described above. Multiple simulations may be conducted using the initial values included in a customized set.

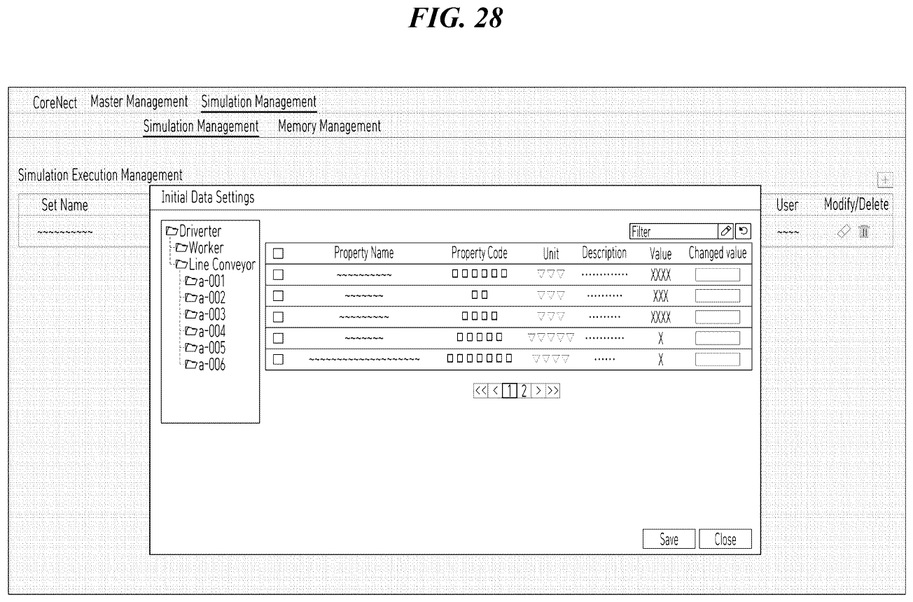

FIG. 28 is a diagram illustrating a screen for editing and managing configurations for each model, according to an embodiment of the present disclosure.

Referring to FIG. 28, according to an embodiment, user initial data may be set up. For example, as the user initial data, names, codes, units, detailed descriptions, and set values of properties may be displayed. Here, a user may set up user set values by inputting changed values for the respective properties. The user set values are initial data to be changed when the user conducts a specific simulation as described above. When conducting a simulation, the user may change conditions of the respective properties to conduct the simulation.

Hereinbefore, various embodiments of the present disclosure and benefits thereof have been described with reference to FIGS. 1-28. The benefits according to the technical spirit of the present disclosure are not limited to those mentioned above. Other benefits, not mentioned above, should be more clearly understood by those having ordinary skill in the art from the above description.

The technical spirit of the present disclosure described above may be embodied as computer-readable code on a computer-readable medium. The computer program recorded on the computer-readable recording medium may be transmitted to another computing apparatus via a network such as the Internet and installed in the other computing device, so that the computer program may be used in the other computing device.

Although operations are shown in a specific order in the drawings, it should be understood that desired results can be obtained not only when the operations are performed in this specific order or a sequential order or when all the operations are performed. In certain situations, multitasking and/or parallel processing may be advantageous.

Although the embodiments of the present disclosure have been described with reference to the accompanying drawings, those having ordinary skill in the art to which the present disclosure pertains should understand that the present disclosure may be modified or altered in other specific forms without changing the technical spirit or essential features. Therefore, the embodiments described above should be understood in all respects as illustrative and not restrictive. The scope of protection of the present disclosure should be interpreted in accordance with the claims below, and all technical ideas within the equivalent scope should be construed as being included in the scope of right of the technical ideas defined by the present disclosure.

What is claimed is:

1. A digital twin system comprising:
multiple twin model modules, wherein respective ones of the twin model modules i) comprise control logic and ii) are configured to virtualize respective control systems for respective ones of multiple factories;
multiple digital factory modules, wherein respective ones of the digital factory modules i) are configured to virtualize respective ones of the multiple factories and ii) are controlled by respective ones of the multiple twin model modules to create a virtual factory model; and
a simulator module configured to manage the multiple twin model modules.

2. The digital twin system of claim 1, wherein the multiple twin model modules are executed on at least one graphics processing unit (GPU) server, and when a first twin model module from among the multiple twin model modules is executed, the simulator module assigns resources for executing the first twin model module in the at least one GPU server.

3. The digital twin system of claim 1, wherein the simulator module is configured to set up conditions of the control logic for controlling a virtual factory in each twin model module.

4. The digital twin system of claim 3, wherein the simulator module is configured to:
create webpages to set up the conditions of the control logic; and
set up the conditions of the control logic using set values inputted through the webpages.

5. The digital twin system of claim 1, wherein the simulator module is configured to request any one of start, end, and restart of a simulation from each twin model module.

6. The digital twin system of claim 1, wherein the simulator module is configured to:
request status information from a twin model module; and
receive the status information from the twin model module.

7. The digital twin system of claim 1, wherein the simulator module comprises a model manager configured to manage connection with each twin model module or each digital factory module.

8. The digital twin system of claim 1, wherein each of the multiple twin model modules is set to be combined with any one of the multiple digital factory modules.

9. The digital twin system of claim 1, further comprising:
a data analyzing module configured to receive data from at least one of each twin model module, each digital factory module, or the simulator module; and
analyze the received data.

10. A method for controlling a digital twin system comprising:
registering and initializing, by a simulator module, models for multiple digital factories, wherein the models for digital factories are virtual representations of multiple factories;
requesting, by the simulator module, start of a simulation from a first twin model from among multiple twin models, wherein the multiple twin models are virtual representations of respective control systems for respective ones of the multiple factories;
generating, by the first twin model, control logic for a first digital factory from among the multiple digital factories;
transferring, by the first twin model, a command generated based on the control logic to a first digital factory module; and
processing, by the first digital factory module, an operation corresponding to the command received from the first twin model to conduct a simulation.

11. The method of claim 10, wherein the simulator module operates on a central processing unit (CPU) server and the multiple twin models are executed on at least one graphics processing unit (GPU) server.

12. The method of claim 11, wherein the models for the multiple digital factories are executed on the at least one GPU server.

13. The method of claim 10, further comprising setting up, by the simulator module, conditions of the control logic for controlling each virtual factory with each twin model module.

14. The method of claim 13, further comprising:
creating, by the simulator module, webpages to set up the conditions of the control logic; and
setting up, by the simulator module, the conditions of the control logic using set values inputted through the webpages.

15. The method of claim 10, wherein each of the multiple twin models is set to be combined with any one of multiple digital factory modules.

16. The method of claim 10, further comprising reporting, by each digital factory module, a result corresponding to a control command to a twin model module connected with this digital factory module.

17. The method of claim 10, further comprising:
receiving, by a data analyzing module, data from at least one of each twin model module, each digital factory module, and the simulator module; and
analyzing, by the data analyzing module, the received data.

18. A graphics processing unit (GPU) server comprising:
Multiple twin model modules, wherein respective ones of the multiple twin model modules i) comprise control logic and ii) are configured to virtualize respective control systems for respective ones of multiple factories; and
multiple digital factory modules, wherein respective ones of the digital factory modules i) are configured to create respective virtual factory models by virtualizing respective ones of the multiple factories and ii) are controlled by respective ones of the multiple twin model modules.

19. The GPU server of claim 18, wherein, when a first twin model module from among the multiple twin model modules is executed, resources for executing the first twin model module are assigned in the GPU server.

20. The GPU server of claim 18, wherein each twin model module is configured to set up conditions of control logic for controlling a virtual factory.
